(19) United States
(12) Patent Application Publication
(10) Pub. No.: US 2024/0281662 A1
(43) Pub. Date: Aug. 22, 2024

(54) System and Methods for Solving Constraint Optimization Problems using Machine Learning

(71) Applicant: Georgia Tech Research Corporation, Atlanta, GA (US)

(72) Inventors: Daehyun Kim, Atlanta, GA (US); Saibal Mukhopadhyay, Atlanta, GA (US)

(21) Appl. No.: 18/581,161

(22) Filed: Feb. 19, 2024

Related U.S. Application Data
(60) Provisional application No. 63/446,838, filed on Feb. 18, 2023.

(51) Int. Cl. G06N 3/088

(52) U.S. Cl. CPC G06N 3/088

(57) ABSTRACT

An exemplary co-processor system and method includes a solver circuit with a neural network configured for unsupervised learning, the solver circuit including: a binary input interface configured to receive binary inputs corresponding to variables and clauses for a Boolean problem; a state machine memory module; neuron circuits coupled to the state machine memory module; a neural network machine memory module having arrays of weights corresponding to nodes in a neural network; a state machine circuit operably coupled to state machine memory module, the binary input interface, and the neural network memory module, where the state machine circuit is configured to (i) compute a score from the Boolean states of the clauses (ii) determine a plurality of learning probabilities to generate a plurality of weights; and (iii) provide the plurality of weights to NN memory module, where the weights of the state machine memory module are iteratively updated through unsupervised learning.

### RELATED APPLICATION

This application claims priority to, and the benefit of, U.S. Provisional Patent Application No. 63/446,838, filed Feb. 18, 2023, entitled “SYSTEM AND METHODS FOR SOLVING CONSTRAINT OPTIMIZATION PROBLEMS USING MACHINE LEARNING,” which is incorporated by reference herein in its entirety.

### TECHNICAL FIELD

This application is directed to an improvement to computer hardware, specifically, digital circuitries for solving mathematical problems.

### BACKGROUND

A Boolean satisfiability (SAT) problem is the problem of determining if there is a set of values that can be input into a Boolean formula so that the Boolean formula evaluates to “true.” SAT problems are important to solve in many technical fields, including communications, flight networks, supply chains, and finance.

Algorithms cannot solve all possible types of SAT problems, and general mathematical solutions to SAT problems are not known. SAT solvers can scale poorly in systems with thousands of variables and/or millions of constraints. Therefore SAT solvers and algorithms are limited in what SAT problems can be practically solved.

There are benefits to systems and methods that improve SAT solvers and other solvers.

### SUMMARY

Embodiments of the present disclosure include digital hardware circuits and devices that can search the solution space for solutions to a Boolean satisfiability problem, e.g., as a digital hardware co-processor or AI chip. Embodiments of the present disclosure include neural network circuitries configured to guide the search of a search space to find optimal solutions to a SAT problem and digital hardware circuitries to set up the neural network.

An exemplary co-processor system and method includes a solver circuit with a neural network configured for unsupervised learning, the solver circuit including: a binary input interface configured to receive binary inputs corresponding to variables and clauses for a Boolean problem; a state machine memory module; neuron circuits coupled to the state machine memory module; a neural network machine memory module having arrays of weights corresponding to nodes in a neural network; a state machine circuit operably coupled to state machine memory module, the binary input interface, and the neural network memory module, where the state machine circuit is configured to (i) compute a score from the Boolean states of the clauses (ii) determine a plurality of learning probabilities to generate a plurality of weights; and (iii) provide the plurality of weights to NN memory module, where the weights of the state machine memory module are iteratively updated through unsupervised learning.

In some aspects, the operation described herein relate to a co-processor (e.g., integrated or external IC) including: a solver circuit (e.g., processing in-memory solver) including a neural network (e.g., recurrent neural network) configured for unsupervised learning, the solver circuit including: a binary input interface configured to receive binary inputs corresponding to variables and clauses for a Boolean problem; a state machine memory module (e.g., RNN memory module) a crossbar array of rows and column, collectively, corresponding to variables and clauses, the crossbar array being used to map and compute Boolean states of clauses, wherein each bit-cell in the array indicates a presence or absence of variables in a clause; neuron circuits (e.g., analog neuron circuits; stochastic neurons) coupled to the state machine memory module to generate assignment of the variables; a neural network acceleration module (e.g., PIM) having arrays of weights corresponding to nodes in a neural network; a state machine circuit (e.g., finite state machine, e.g., FSM) operably coupled to state machine accelerator module, the binary input interface, and the neural network acceleration module, wherein the state machine circuit is configured to (i) compute a score from the Boolean states of the clauses from weights in the variable state memory (ii) determine a plurality of learning probabilities to generate a plurality of weights based on the plurality of learning probabilities; and (iii) provide the plurality of weights to NN memory module, wherein the weights of the state machine memory module are iteratively updated through unsupervised global learning rules and local learning rules, the global learning guides the system towards the higher number of satisfied clauses, and the local learning helps the system to explore the local problem region.

In some aspects, the techniques described herein relate to a co-processor, wherein the state machine circuit includes a 1 circuit (e.g., probability processor circuit) configured to output the plurality of learning probabilities (e.g., a global learning probability vector that is applied to all weights and local learning probability vector that is applied to a column or row).

In some aspects, the techniques described herein relate to a co-processor, wherein the state machine circuit includes a weight update circuit operably coupled to the probability processor circuit, wherein the weight update circuit is configured to determine the plurality of weights using the plurality of learning probabilities.

In some aspects, the techniques described herein relate to a co-processor, wherein the neuron circuits include analog neuron circuits having adjustable randomness.

In some aspects, the techniques described herein relate to a co-processor, wherein the neuron circuits include stochastic neurons.

In some aspects, the techniques described herein relate to a co-processor, wherein at least one of the state machine memory modules and the neural network memory module includes a processing in memory (PIM) controller.

In some aspects, the techniques described herein relate to a co-processor, wherein at least one of the state machine memory modules and the neural network memory module includes SRAM.

In some aspects, the techniques described herein relate to a co-processor, wherein the state machine circuit includes a digital finite-state machine (FSM) configured to compute the current satisfiability score from the Boolean states of the clauses and update the weights to the NN memory module to control the stochasticity of the neuron circuits.

In some aspects, the techniques described herein relate to a co-processor, wherein the state machine circuit includes an input filter configured to process the assignment of the variables to map an input vector to an output vector according to a set of predefined rules.

In some aspects, the techniques described herein relate to a co-processor, wherein the neural network includes a recurrent neural network.

In some aspects, the techniques described herein relate to a co-processor, wherein the co-processor is implemented with a host processing unit.

In some aspects, the techniques described herein relate to a co-processor, wherein the co-processor is implemented as an external integrated circuit.

In some aspects, the techniques described herein relate to a co-processor, wherein the solver circuit is configured to solve a Boolean Satisfiability problem (SAT).

In some aspects, the techniques described herein relate to a method for evaluating satisfiability, the method including: receiving binary inputs corresponding to variables and clauses for a Boolean problem; mapping a plurality of Boolean states corresponding to the clauses of the Boolean problem; generating an assignment of variables based on the Boolean problem by a plurality of neuron circuits; computing a score for the assignment of variables; determining a plurality of learning probabilities to generate a plurality of weights based on the plurality of learning probabilities; inputting the plurality of weights to a neural network acceleration module, wherein the neural network acceleration module is configured to update the weights of a state machine memory module iteratively to guide a solver toward a higher number of satisfied clauses of the Boolean problem.

In some aspects, the techniques described herein relate to a method, wherein the plurality of neuron circuits include analog neuron circuits having adjustable randomness.

In some aspects, the techniques described herein relate to a method, wherein the plurality of neuron circuits include stochastic neurons.

In some aspects, the techniques described herein relate to a method, wherein the Boolean problem includes a Boolean SAT.

In some aspects, the techniques described herein relate to a method, wherein the state machine memory module includes a processing in memory (PIM) controller.

In some aspects, the techniques described herein relate to a method, further including filtering the binary inputs based on a set of predefined rules.

In some aspects, the techniques described herein relate to a method, wherein the plurality of learning probabilities include global learning probabilities and local learning probabilities.

### BRIEF DESCRIPTION OF THE DRAWINGS

The skilled person in the art will understand that the drawings described below are for illustration purposes only.

FIG. 1A shows an example system including a host processor and solver processor in accordance with illustrative embodiments.

FIG. 1B shows an example system including a processing unit and a solver co-processor in accordance with illustrative embodiments.

FIG. 1C shows an example system including a networked solver co-processor in accordance with illustrative embodiments.

FIG. 2A shows a block diagram of an example co-processor in accordance with illustrative embodiments.

FIG. 2B shows a block diagram of another example co-processor in accordance with illustrative embodiments.

FIG. 3A shows an example processing-in-memory (PIM) solver in accordance with illustrative embodiments.

FIG. 3B shows an exemplary microarchitecture for a PIM solver in accordance with illustrative embodiments.

FIG. 3C shows an example PIM solver configured with a CT-SRNN and an FT-FSM in accordance with illustrative embodiments.

FIG. 4A shows an example RNN input filter (RIF) and RNN PIM module for a PIM solver in accordance with illustrative embodiments.

FIG. 4B illustrates a block diagram of a stochastic neuron in accordance with illustrative embodiments.

FIG. 4C illustrates an example circuit implementation of a stochastic neuron in accordance with illustrative embodiments.

FIG. 4D illustrates an example SAT input filter and SAT-PIM module, according to an example embodiment of the present disclosure.

FIG. 4E illustrates an example SAT problem mapping on SAT-PIM memory and PIM peripheral details, according to an example embodiment of the present disclosure.

FIG. 4F illustrates an example probability processor, according to embodiments of the present disclosure.

FIG. 4G illustrates an example weigh update module (WUM) block diagram, according to embodiments of the present disclosure.

FIG. 4H illustrates a simulated system dynamics representation using cost function, SAT, network weight matrix, and activity of neurons for an example embodiment of the present disclosure.

FIGS. 5A-5L show an example design of the machine-learning solver processor developed in a study and its associated performance.

FIG. 6A-6E show additional implementation details and control operation of the hardware components of FIGS. 4A-4G.

FIG. 7A shows the operation of the exemplary system and method that employs the temporal gradient of the variable set and the projected variable's local information.

FIG. 7B shows an example of the use of systems of FIG. 1A, 1B, or 1C, according to embodiments of the present disclosure; FIG. 7C shows an example of a 3-SAT problem that is an example application of FIG. 7B.

### DETAILED SPECIFICATION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the nth reference in the list. For example, [1] refers to the first reference in the list. All references cited and discussed in this specification are incorporated herein by reference in their entireties and to the same extent as if each reference was individually incorporated by reference.

Some computer science problems cannot be solved using algorithms, and must instead be solved by searching for solutions in a large solution space. The demands of searching large solutions spaces mean that there are advantages to developing specialized “solver” hardware that can act as “co-processors” that systems can use to solve complex problems by searching the solution space. As an example, the Boolean satisfiability problem (referred to herein as SAT or SAT problem) is the problem of determining whether a Boolean formula with certain conditions can evaluate to “true” with certain inputs. Other example types of satisfiability problem include “Sharp SAT” (counting the number of ways to evaluate a formula to true) and Planar SAT (a Boolean SAT problem applied to a planar incidence graph). It should be understood that while embodiments of the present disclosure are described with reference to Boolean SAT, other types of problems, including Sharp SAT and/or Planar SAT can be solvable using embodiments of the present disclosure.

### Example Systems

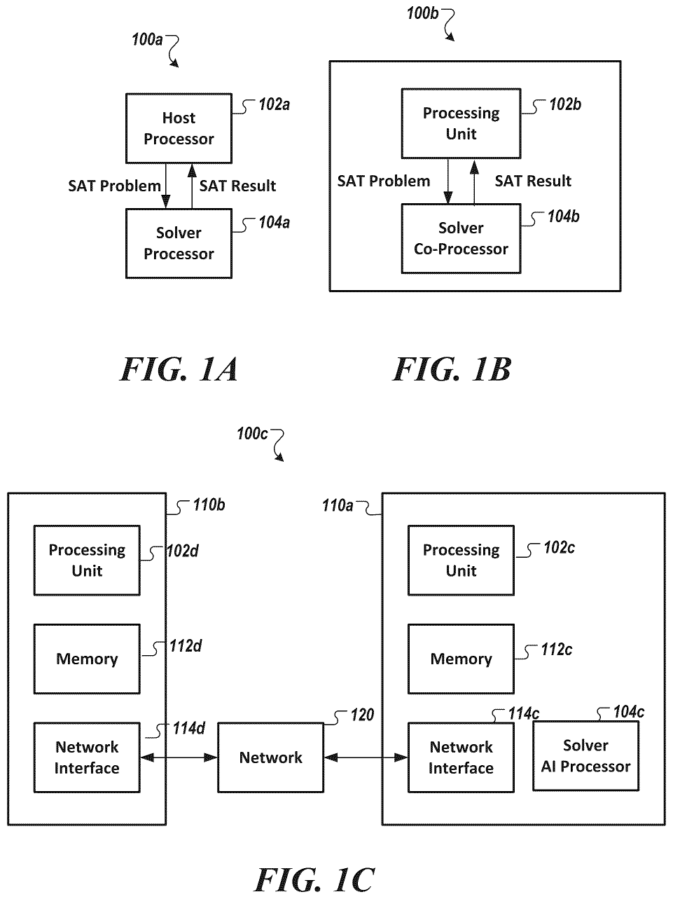

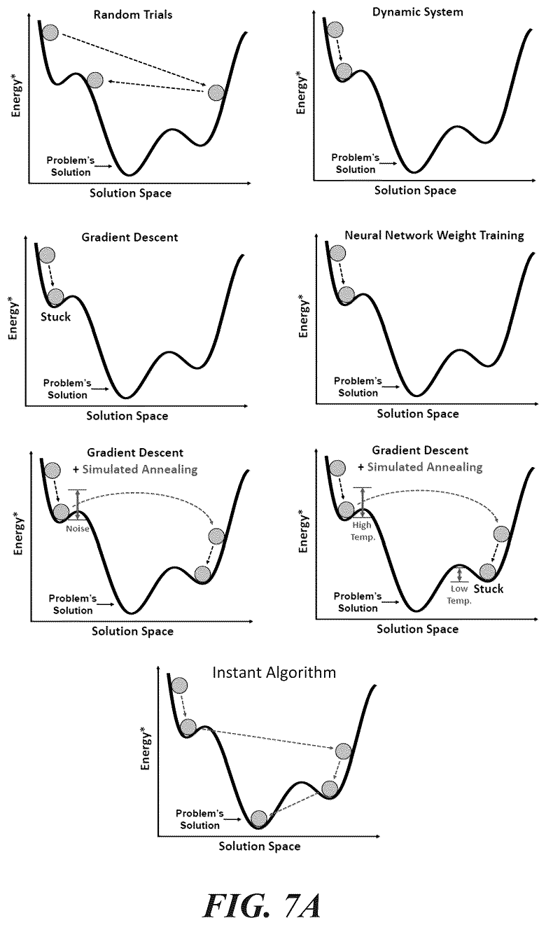

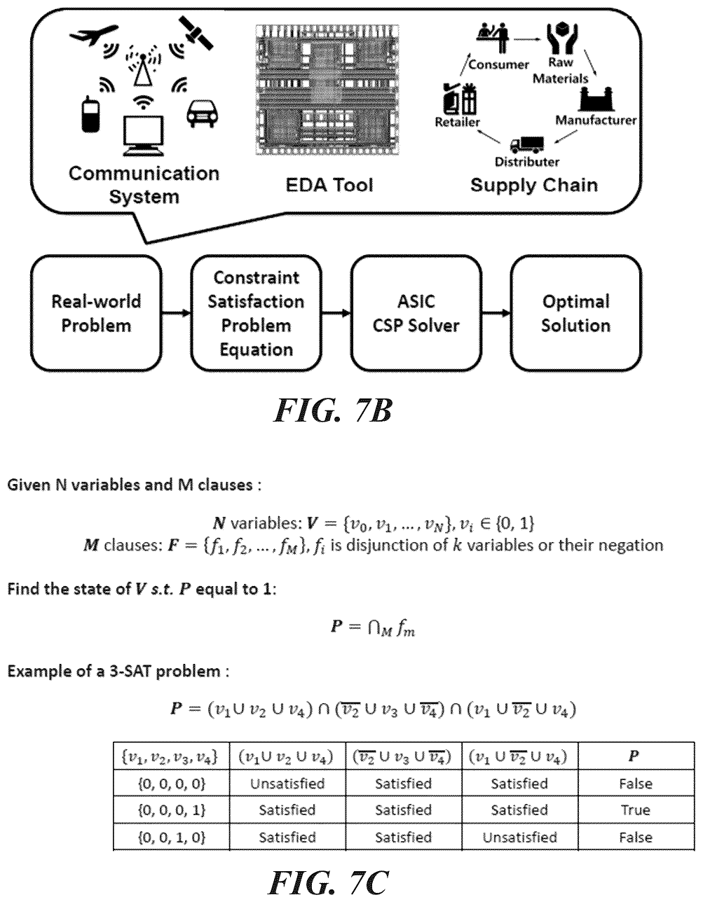

FIGS. 1A-IC each shows a system 100 (shown as 100a, 100b, 100c) that includes solver processors and/or solver co-processors with a neural network circuit configured for unsupervised learning to solve a Boolean problem in accordance with an illustrative embodiment. FIG. 7B shows an example of the use of systems (e.g., of 100a, 100b, 100c). Constraint optimization problems have emerged as widely applicable tools and have brought vital improvements to many real-world problems, such as communication systems, EDA tools and supply chains. The exemplary system and method can be used for Boolean-associated problems, as well as other constraint optimization problems.

Solver processor. In the example shown in FIG. 1A, the example system 100a includes a host processor 102a and a solver processor 104a. The host processor 102a and the solver processor 104a may be co-located on the same printed circuit board or digital control board through a bus interface. In some embodiments, the solver processor 104a is implemented as a breakout board that can couple to a bus interface located on a motherboard having the host processor 102a.

The solver processor 104a includes the solver circuit (e.g., processing in-memory solver) that includes (i) a neural network (e.g., recurrent neural network) configured for unsupervised learning, to search in the solution space for a Boolean problem and (ii) a digital hardware circuits to configured the neural network to do the same. The solver circuit includes a binary input interface configured to receive binary inputs corresponding to variables and clauses for a Boolean problem, a state machine memory module (e.g., RNN memory module) a crossbar array of rows and columns, collectively, corresponding to variables and clauses. The crossbar array can map and compute Boolean states of clauses, wherein each bit-cell in the array indicates the presence or absence of variables in a clause. The solver processor 104a includes neuron circuits (e.g., analog neuron circuits; stochastic neurons) coupled to the state machine memory module to generate the assignment of the variables. The solver processor 104a includes a neural network acceleration module (e.g., PIM), among other memory topologies, e.g., having arrays of weights corresponding to nodes in a neural network. The solver processor 104a includes a state machine circuit (e.g., FSM) operably coupled to the state machine accelerator module, the binary input interface, and the neural network acceleration module. The state machine circuit is configured to (i) compute a score from the Boolean states of the clauses from weights in the variable state memory (ii) determine a plurality of learning probabilities to generate a plurality of weights based on the plurality of learning probabilities; and (iii) provide the plurality of weights to NN memory module, wherein the weights of the state machine memory module are iteratively updated through unsupervised global learning rules and local learning rules, the global learning guides the system towards the higher number of satisfied clauses, and the local learning helps the system to explore the local problem region.

The host processor 102a can be a general-purpose processor configured to execute on a set of instructions, e.g., CISC or RISC microprocessor. The host processor 102a can interface with a memory, input devices, and display to execute an software application, e.g., for analysis or controls, having a mathematical Boolean problem (e.g., SAT problem). The host processor 102a can, e.g., execute instructions having a call function for the Boolean problem. The host processor 102a can generate, via middleware, a list of variable elements and clause elements as the SAT problem to be provided to the solver processor 104a.

Solver Co-Processor. With reference to FIG. 1B, embodiments of the present disclosure include systems 100b comprising a processing unit 102 (shown as 102b) configured as part of a single integrated processing unit comprising a solver co-processor 104b. The processing unit 102b and the co-processor 104b maybe implemented in a single package.

The solver co-processor 104b includes the solver circuit (e.g., processing in-memory solver) that includes (i) a neural network (e.g., recurrent neural network) configured for unsupervised learning to search in the solution space for a Boolean problem and (ii) a digital hardware circuits to configured the neural network to do the same. The solver circuit includes a binary input interface configured to receive binary inputs corresponding to variables and clauses for a Boolean problem; a state machine memory module (e.g., RNN memory module) a crossbar array of rows and column, collectively, corresponding to variables and clauses. The crossbar array can map and compute Boolean states of clauses, wherein each bit-cell in the array indicates the presence or absence of variables in a clause. The solver co-processor 104b includes neuron circuits (e.g., analog neuron circuits; stochastic neurons) coupled to the state machine memory module to generate the assignment of the variables. The solver co-processor 104b includes a neural network acceleration module (e.g., PIM), among other memory topologies, e.g., having arrays of weights corresponding to nodes in a neural network. The solver co-processor 104b includes a state machine circuit (e.g., FSM) operably coupled to the state machine accelerator module, the binary input interface, and the neural network acceleration module. The state machine circuit is configured to (i) compute a score from the Boolean states of the clauses from weights in the variable state memory (ii) determine a plurality of learning probabilities to generate a plurality of weights based on the plurality of learning probabilities; and (iii) provide the plurality of weights to NN memory module, wherein the weights of the state machine memory module are iteratively updated through unsupervised global learning rules and local learning rules, the global learning guides the system towards the higher number of satisfied clauses, and the local learning helps the system to explore the local problem region.

In some embodiments, the processing unit 102b is coupled to the solver co-processor 104b through a shared memory interface, e.g., the memory of the solver co-processor. The processing unit 102b and the co-processor 104b may each include a memory controller to read and write to the shared memory. In some embodiments, the memory share controller is shared between the processing unit 102b and the co-processor 104b.

AI Processor. With reference to FIG. 1C, embodiments of the present disclosure further include systems 100c comprising a solver AI processor 104 (shown as 104c) that operates in a cloud infrastructure 110 (shown as 110a). The cloud infrastructure 110a is operatively coupled to a computing device 110 (shown as 110b) that executes a software application, e.g., for analysis or controls, having a mathematical Boolean problem (e.g., SAT problem). The computer device 110b, during the operation of the application, transmits a Boolean problem to solver AI processor 104c of the cloud infrastructure 110a. In the example shown in FIG. 1C, the cloud infrastructure 110a includes one or more computing devices in which at least one of the computing devices includes a processing unit (shown as 102c) and memory (shown 112c) that operates with the solver AI processor 104c.

The solver AI processor 104c includes the solver circuit (e.g., processing in-memory solver) that includes (i) a neural network (e.g., recurrent neural network) configured for unsupervised learning to search in the solution space for a Boolean problem and (ii) a digital hardware circuits to configured the neural network to do the same. The solver circuit includes a binary input interface configured to receive binary inputs corresponding to variables and clauses for a Boolean problem; a state machine memory module (e.g., RNN memory module), having a crossbar array of rows and columns, collectively, corresponding to variables and clauses. The crossbar array can map and compute Boolean states of clauses, wherein each bit-cell in the array indicates the presence or absence of variables in a clause. The AI processor 104c includes neuron circuits (e.g., analog neuron circuits; stochastic neurons) coupled to the state machine memory module to generate the assignment of the variables. The solver AI processor 104c includes a neural network acceleration module (e.g., PIM), among other memory topologies, e.g., having arrays of weights corresponding to nodes in a neural network. The solver AI processor 104c includes a state machine circuit (e.g., FSM) operably coupled to the state machine accelerator module, the binary input interface, and the neural network acceleration module. The state machine circuit is configured to (i) compute a score from the Boolean states of the clauses from weights in the variable state memory and (ii) determine a plurality of learning probabilities to generate a plurality of weights based on the plurality of learning probabilities; and (iii) provide the plurality of weights to NN memory module, wherein the weights of the state machine memory module are iteratively updated through unsupervised global learning rules and local learning rules, the global learning guides the system towards the higher number of satisfied clauses, and the local learning helps the system to explore the local problem region.

Each of the computing devices 110a, 110b includes a network interface 114c, 114d, respectively, each configured to communicate over a network 120 (e.g., a wired network, wireless network, or any combination of wired and wireless network. The application computing device 110b includes a processing unit 102d, a memory 112d, and the network interface 114d.

In some embodiments, the computing device of the cloud infrastructure 110a is configured to provide the solution to the application computing device 110b. In other embodiments, the computing device of the cloud infrastructure 110a is configured to provide the solution to another application computing device (not shown).

### Example Solver Digital Hardware Circuit

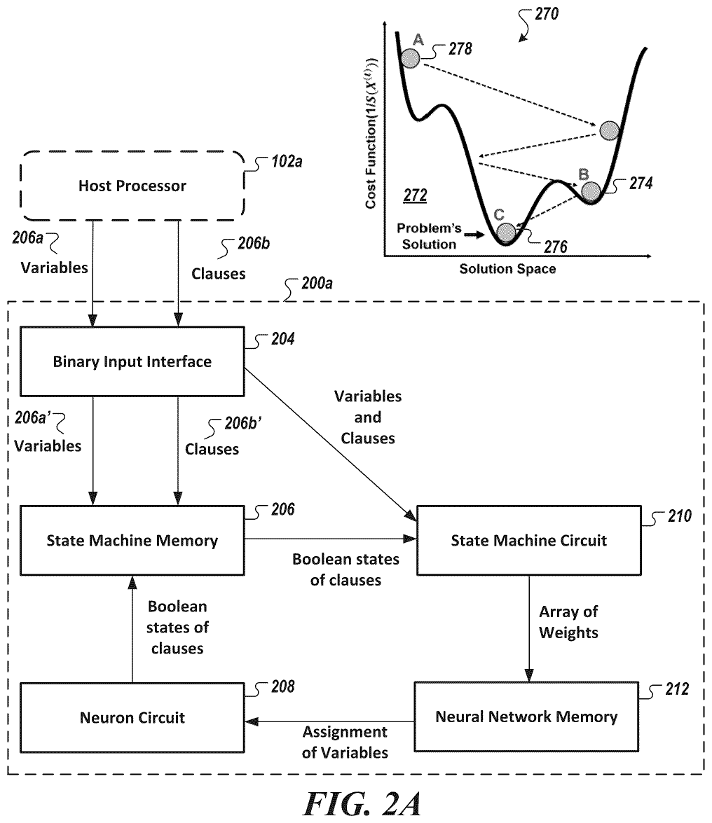

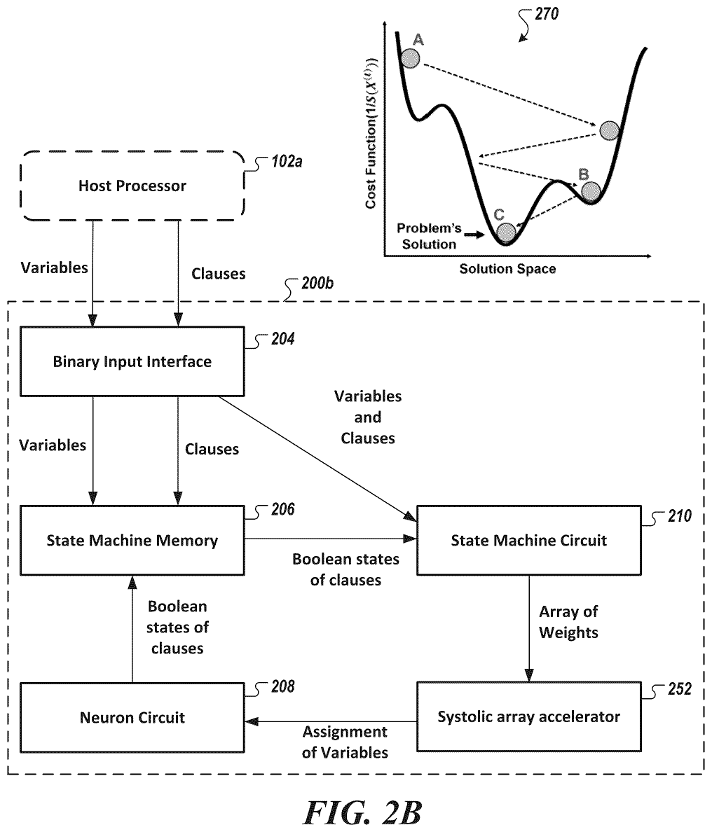

FIG. 2A shows an example block diagram of a solver digital hardware circuit (e.g., 104a, 104b, 104b; now shown as 200a) in accordance with an illustrative embodiment. As described in relation to FIGS. 1A-1C, the solver circuit 200a can be implemented as a networked computing device (e.g., 104c), a co-processor (e.g., 104b), and/or a processor (e.g., 104a). In the example shown in FIG. 2A, the solver circuit 200a operates with the host processor 102a to configure and then search, via a neural network circuit, for a solution to a Boolean problem. In other embodiments, the solver circuit 200a can interface with the processing unit 102b or processing unit 102c. The solver circuit 200a includes a binary interface 202, a state machine memory 206, a neural circuit 208, a state machine circuit 210, and a neural network memory module 212.

Binary Input Interface. The binary input interface 204 is configured to receive variable elements 206a and clause elements 206b associated with a Boolean problem, e.g., a SAT problem, from a processor (e.g., 102a, 102b, 102c) and provide them (shown as 206a′, 206b′) to the state machine memory 206.

State Machine Memory. The state machine memory module 206 is operably coupled to the binary input interface 202 and includes a memory (e.g., static random access memory (SRAM)), e.g., a processing-in-memory, and a crossbar array of rows and columns, that correspond to variables and clauses received from the binary input interface 202. The crossbar array can map and be used to compute the Boolean states of clauses in having a plurality of bit cells to which each bit cell indicates the presence or absence of variables in a clause.

In some embodiments, the state machine memory module 206 includes a processing-in-memory controller to operate with the memory cells to perform data operations directly on the data memory without having to transfer the data to CPU registers for processing.

In some embodiments, the state machine memory module 206 is configured as an RNN memory module.

State Machine Circuit. A state machine circuit 210 is coupled to the state machine memory module 206, the binary input interface 202, and the neural network memory module 212 and is configured to, among other things, (i) compute a score (e.g., an SAT score) from the Boolean states of the clauses 214 (ii) compute learning probabilities (e.g., global learning probability and local learning probability scores or values) for the unsupervised learning, and (iii) compute updated weights for the neural network (e.g., memory 212). A non-limiting example of a global learning probability is a vector that is applied to all weights. A non-limiting example of a local learning probability vector is a vector that is applied to a column or row). In some embodiments, the state machine circuit 210 includes a probability processor circuit configured to compute and output the learning probabilities.

The state machine circuit 210 can iteratively generate updated weights for the neural network through unsupervised global learning rules and local learning rules and provide the updated weights to the state machine memory module 206. Global learning, via the global learning rules, includes a set of operations that guide the number of satisfied clauses, and local learning, via the local learning rules, includes a set of operations that searches non-local regions for solutions, e.g., exploring the local problem region in the SAT problem. Examples of global learning rules and local learning rules are later described herein, along with the description for determining global and local learning probabilities.

Plot 270 shows an example operation by the neural network to search to find global and/or local solutions in solution space 272. The solution space 272 can include local solution B (274) and global solution C (276), obtained from starting point A (278) for Boolean states. Local learning helps the system escape local minima such as local solution B. Global learning helps the system find a global solution C to the problem overall.

In some embodiments, the state machine circuit 210 is configured with an input filter circuit configured to encode the assignment of the variables by mapping an input vector to an output vector according to a set of predefined encoding rules. Non-limiting examples of encoding a problem onto a state machine memory module 206 using an input filter are described in additional detail in the study herein.

In some embodiments, the state machine circuit 210 is configured with a weight update circuit configured to determine the updated weights for the neural network to perform global and local learning.

In some embodiments, the state machine circuit 210 is configured with a digital finite-state machine (FSM) configured to compute a current satisfiability score from the Boolean states of the clauses and updates the weights to neural network memory module or neural network acceleration module 212 to control the stochasticity of the neuron circuits.

Neural Network Memory. The neural network memory module 212 is operably coupled to state machine circuit 210 and includes a memory (e.g., static random access memory (SRAM)), e.g., a processing-in-memory, to store arrays of weights to nodes in a neural network (e.g., an RNN), implemented in part with the neuron circuit 212.

Neuron Circuit. The neuron circuits 208 is coupled to the state machine memory module 206 and the neural network memory module 212 and is a mixed-signal circuit (e.g., analog circuit) that receives and generates assignments (values and/or probabilities) from the neural network memory module 212, to operate the neural network (e.g., RNN). In some embodiments, the neuron circuits 208 is configured as a stochastic neuron circuit, e.g., having neurons where probabilities are assigned (instead of values). In some embodiments, the neuron circuits 208 implement stochastic neurons using analog circuitry that can include adjustable randomness for the stochastic neurons. It should be understood that analog and stochastic neurons are intended only as examples and that other types of neuron circuits can be used in other embodiments of the present disclosure.

Systolic Array Accelerator. FIG. 2B shows an example block diagram of a solver digital hardware circuit (e.g., 104a, 104b, 104b; now shown as 200b) in accordance with an illustrative embodiment. In the example shown in FIG. 2B, the solver circuit 250 includes as a systolic array accelerator 252. A systolic array accelerator includes a network of data processing units grouped into cells. The data processing units can compute a result or partial result of a function and store the result of that computation within the data processing unit. The systolic array can function similarly to the processing-in-memory (PIM) devices described herein by combining memory and processing operations.

### Example Boolean Mathematical Problem

One example of the Boolean mathematical problem to be solved exemplary system and method is the Boolean Satisfiability Problem. In addition to the Boolean Satisfiability Problem, other logical problems may be solved using the exemplary system and method, including . . . .

Boolean Satisfiability Problem. The Boolean Satisfiability problem (SAT) is a canonical problem in the field of computer science and logic. The Boolean SAT problem is concerned with determining the existence of a truth assignment for a set of Boolean variables that satisfies a given Boolean formula. Specifically, the objective is to identify a configuration of variable assignments that results in the formula evaluating to true.

A SAT formula, denoted as P, can be established with a set of Boolean variables represented by V. Each variable vᵢ∈V, where i∈1, 2, . . . , n, can take on one of two truth values: true or false (V∈{0,1}ⁿ). A literal uⱼ, where j∈1, 2, . . . , k and k is the total number of literals in a clause, can be either a variable vᵢ or its negation, ¬vᵢ.

X can represent the assignment of variables in the SAT formula P(X∈{0,1}ⁿ) in which the assignment of variables X is a vector with the same width as the number of variables in the formula, and each element in the assignment of variables X corresponds to a truth value assigned to a variable in V. In other words, X is an assignment vector that maps each variable vᵢ∈V to either true or false.

A Boolean formula P can then be expressed in conjunctive normal form (CNF) as a conjunction of clauses, where each clause is a disjunction of literals. The CNF representation of P can be written per Equation 1.

$$P := {C}_{1} ⋀ {C}_{2} ⋀ … ⋀ {C}_{m} , \qquad ( Eq . 1 )$$

$$where$$

$$A ⋀ B = \{ \begin{matrix}True , & A = True and B = True \\ False , & otherwise .\end{matrix}$$

In Equation 1, Cᵢ is a clause, and m denotes the total number of clauses. The conjunction operator ∧ represents the logical “AND” operation and may operate on two Boolean expressions A and B. Each clause Cᵢ may then be represented as a disjunction of one or more literals per Equation 2.

$${C}_{i} := ( {u}_{1} ⋁ {u}_{2} ⋁ … ⋁ {u}_{k} ) , \qquad ( Eq . 2 )$$

$$where$$

$$A ⋁ B = \{ \begin{matrix}True , & A = True and B = True \\ False , & otherwise .\end{matrix}$$

In Equation 2, the disjunction operator V represents the logical “OR” operation. It operates on two Boolean expressions A and B.

The SAT problem may involve determining whether there exists an assignment of truth values to the variables vᵢ, such that P evaluates to true. The problem can be classified as NP-complete. Existing software-based SAT solvers are used in various domains, including artificial intelligence, hardware and software verification, and optimization.

Definitions of SAT. The first function Cᵢ(X) may represent the application of the assignment X to the clause Cᵢ that can generate a Boolean result, either true or false.

The assignment of variables X may be a vector with the same width as the number of variables. The function Cᵢ(X) may evaluate the clause Cᵢ based on the truth assignment provided by the assignment X. For each literal uⱼ in the clause Cᵢ, the exemplary system and method may retrieve the corresponding assignment X. Then, the exemplary system and method may compute the disjunction of these assignments for all k literals in the clause. If the result of the disjunction is true, then the clause Cᵢ is satisfied under the assignment X; otherwise, it is not.

The function Cᵢ(X) may be defined as Cᵢ(X):=Xᵤ_{₁}∧Xᵤ_{₂}∧ ⋅ ⋅ ⋅ ∧Xᵤ_{ₖ}, where Xᵤ_{ⱼ} denotes the truth assignment for the literal uⱼ in the assignment vector X.

SAT Search Space. To evaluate the entire SAT formula P with the assignment vector X, the definition can be extended to apply the assignment X to each clause Cᵢ in the formula using the function Cᵢ(X). The result can be a vector P(X) per Equation 3 of Boolean values that represent the evaluation of each clause under the assignment X.

$$P ( X ) = \{ {C}_{1} ( X ) , {C}_{2} ( X ) , … , {C}_{m} ( X ) \} \qquad ( Eq . 3 )$$

In Equation 3, P(X) is a vector containing the evaluation results of all m clauses in the SAT formula P under the given assignment X.

The negation of the evaluation results can be defined for the entire SAT formula P under the assignment X. To achieve this, the result of each clause evaluation Cᵢ(X) can be negated in the vector P(X) to provide negated vector P̅(̅X̅)̅, per Equation 4.

$$\overline{P ( X )} = \{ \overline{{C}_{1} ( X )} , \overline{{C}_{2} ( X )} , … , \overline{{C}_{m} ( X )} \} \qquad ( Eq . 4 )$$

A function S(X) (SAT score) can be determined that computes the sum of the elements in the vector P(X) to essentially count the number of clauses that are evaluated to true under the assignment X, per Equation 5. The function S(X) can determine how many clauses are satisfied by a given assignment X.

$$S ( X ) = {\sum }_{i = 1}^{m} {C}_{i} ( X ) \qquad ( Eq . 5 )$$

Notation X^{(t)} can be used to represent the assignment at a specific time t, per Equation 6. In Equation 6, X^{(t)} is the assignment of variables at time t, and xᵢ^{(t)} represents the value of the variable vᵢ at time t. Equation 6 allows the assignment of variables to be tracked at different time steps and allows for analysis of the changes over time.

$${X}^{( t )} = \{ {X}_{1}^{( t )} , {X}_{2}^{( t )} , … , {X}_{n}^{( t )} \} \qquad ( Eq . 6 )$$

Given the assignment X^{(t)} at time t, P(X^{(t)}) can represent the evaluation of the SAT formula P using the assignment X^{(t)}. P(X^{(t)}) can be a vector containing the evaluation results of all clauses Cᵢ with the assignment X per Equation 7.

$$P ( {X}^{( t )} ) = \{ {C}_{1} ( {X}^{( t )} ) , {C}_{2} ( {X}^{( t )} ) , … , {C}_{m} ( {X}^{( t )} ) \} \qquad ( Eq . 7 )$$

A function S(X^{(t)}) can be employed to calculate the sum of the elements in the vector P(X^{(t)}), to give the total number of clauses that evaluate to true for the given assignment X^{(t)} per Equation 8.

$$S ( {X}^{( t )} ) = {\sum }_{i = 1}^{m} {C}_{i} ( {X}^{( t )} ) \qquad ( Eq . 8 )$$

Equation 8 allows for the analysis of the assignment X^{(t)} and its influence on the SAT formula P at a time step t.

### Example RNN Solver Digital Hardware Circuit

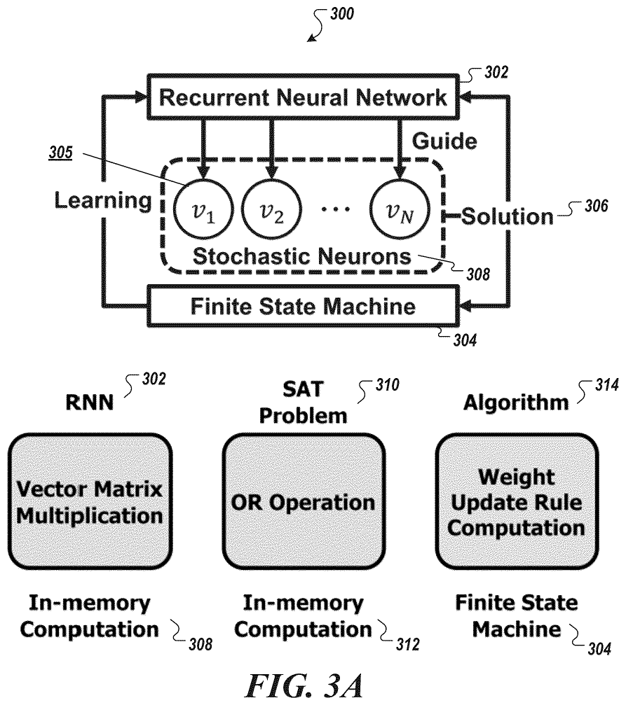

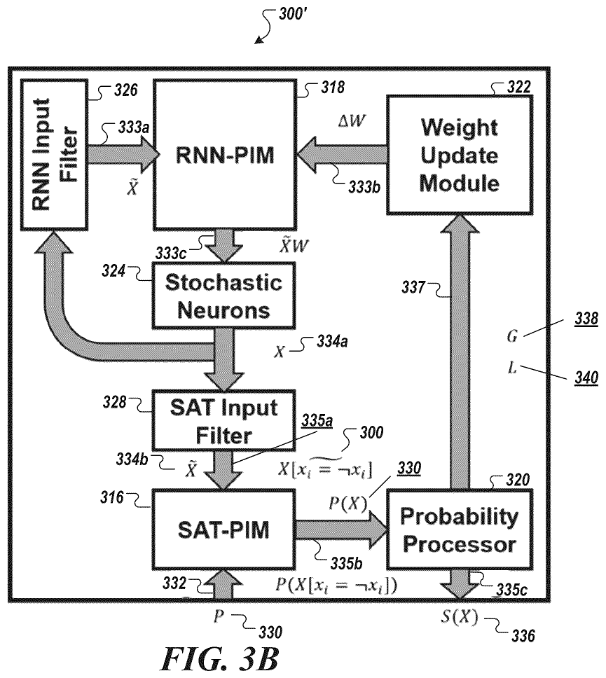

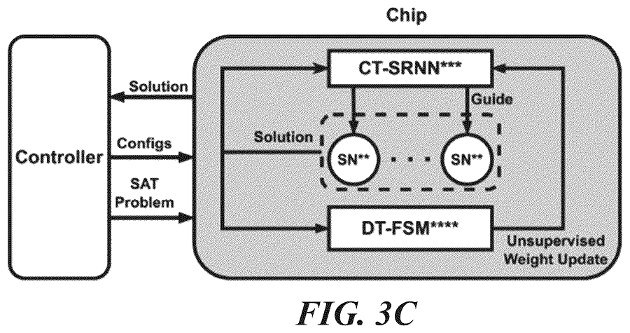

FIG. 3A shows an example embodiment of an RNN solver digital hardware circuit 300. The recurrent neural network 302 operates, in this example, with a finite state machine 304, and provides variables 305 (shown as vᵢ, v₂, . . . v_{N}) to stochastic neurons 308 that can search the solution space (e.g., 272) to a solution 306. Other state machines can be used as described or referenced herein. The process in FIG. 3A can be repeated iteratively towards a global and/or local solution, as described with reference to the solution space 270 in FIGS. 2A and 2B.

FIG. 7A shows the operation of the exemplary system and method (shown as instant algorithm 702) that employs the temporal gradient of the variable set and the projected variable's local information. It can provide improved search space over simulated annealing, gradient descent, neural network with weight training, dynamic system, and random trials. It is contemplated that any of the methodologies can be used in the context of exemplary digital computing hardware.

A recurrent neural network (RNN) (e.g., 302) is one of two classes of artificial neural networks characterized by the direction of the flow of information between its layers. The RNN is a bi-directional artificial neural network that allows the output from some nodes to affect subsequent input to the same nodes. In addition to RNN (e.g., 302), other neural network topologies can be similarly implemented, e.g., uni-directional feedforward neural network. Additional examples of other neural network topologies include, but are not limited to, Long short-term memory (LSTM), graph neural network, and convolutional neural network, among others described or referenced herein.

In some embodiments, the RNN 302 may be configured for in-memory computation 308, e.g., employing vector-matrix multiplication, the SAT problem 310 may be configured for in-memory computation 312, e.g., employing Boolean OR operators, and the overall algorithm 314 may be maintained by the finite state machine 304, e.g., to compute weight updates for the RNN and compute updated rules.

CT-RNN and DT-FSM. FIG. 3C shows an example PIM solver that includes a continuous time stochastic recurrent neural network, stochastic neurons, and discrete-time finite state machine. The recurrent neural network guides the stochastic neurons to search for the solution. The stochastic neurons explore the solution space based on the guidance of RNN. The discrete finite state machine verifies the solution, calculates the weight update probability, and updates the RNN weights. The controller sets the configuration and the SAT problem on the chip and receives the variable set and the satisfaction score.

Solver Digital Hardware Circuit. FIG. 3B shows an example implementation of a microarchitecture circuit for an RNN solver digital hardware circuit 300 (shown as 300′) with PIM solver hardware. The PIM solver 300′ includes a SAT-PIM 316, an RNN-PIM 318, a probability processor 320, a weight update module 322, stochastic neurons 324, RNN input filter 326, and SAT input filter 328. The PIM solver 300′ is configured to perform hardware accelerated operations such as processing in memory, neural network acceleration, or systolic array accelerator, among others described herein.

The PIM solver 300′ can first receive a SAT problem P (330) and write (332) the SAT problem P (330) to the SAT-PIM memory array of SAT-PIM 316. The RNN input filter 326, RNN-PIM 318, and stochastic neurons 324 can then generate (333a, 333b, 333c) the assignment of variables X (334a) for the SAT-PIM 316. The values of the stochastic neurons 324 are used both as inputs to the recurrent neural network 318 and as inputs to the SAT input filter 328, which processes the values before the values are input into the SAT-PIM. The SAT-PIM (316) is configured to evaluate the SAT formula P using the assignment X) to generate P(X) (330) (e.g., Equation 7) as its output to the probability processor 320. The probability processor 320 can calculate (335a, 335b, 335c) a satisfiability score S(X) (336) and a global learning probability G (338) based on the values of the assignment X (334a) to provide (337) the global learning probability G (338) to the weight update module 332. The probability processor 320 can then calculate a local learning probability L (340) and provide (339) the local learning probability L (340) to the weight update module 332. The weight update module 332 then updates (341) the weights W in the memory array of the RNN-PIM 318 based on G (338) and L (340). The loop formed by the SAT-PIM 316, probability processor 320, weight update module 322, recurrent neural network 318, stochastic neurons 324, SAT input filter 328, and recurrent neural network input filter 326 can be used to iteratively output solutions by the probability processor 320 and thereby find global and/or local solutions.

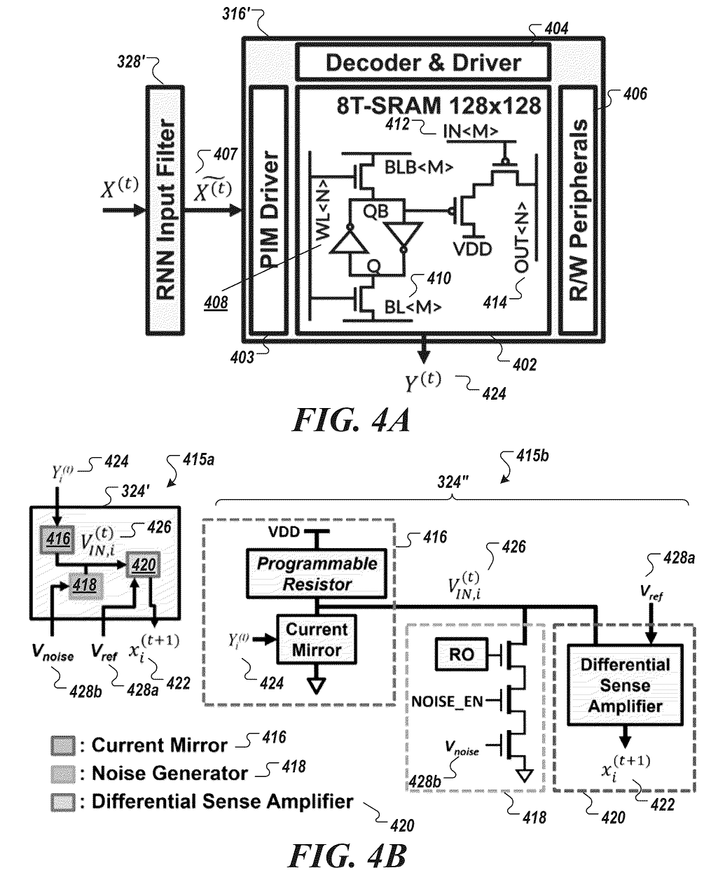

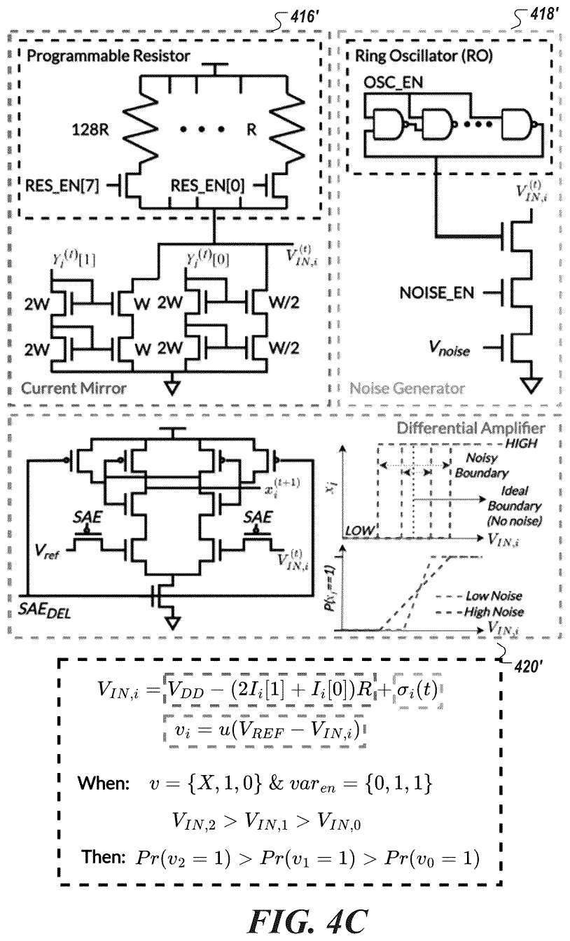

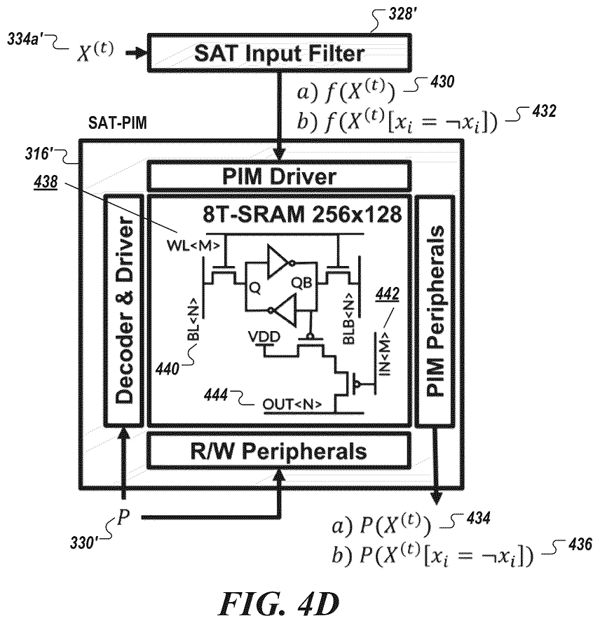

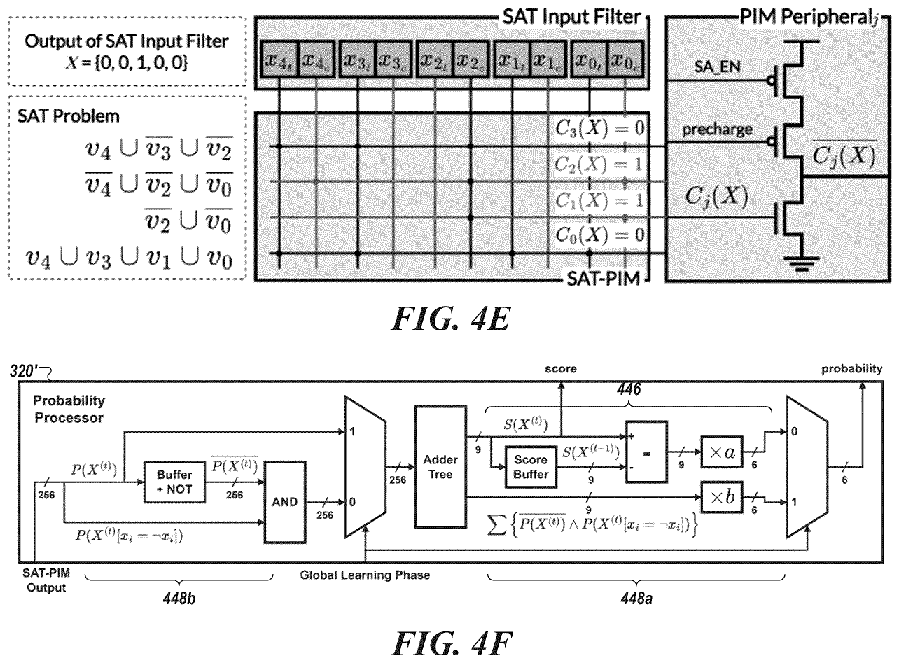

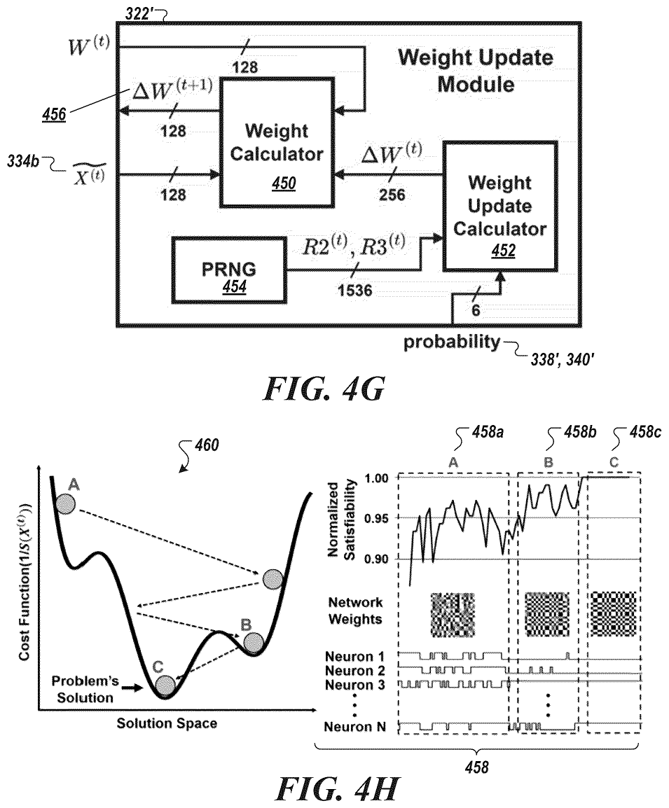

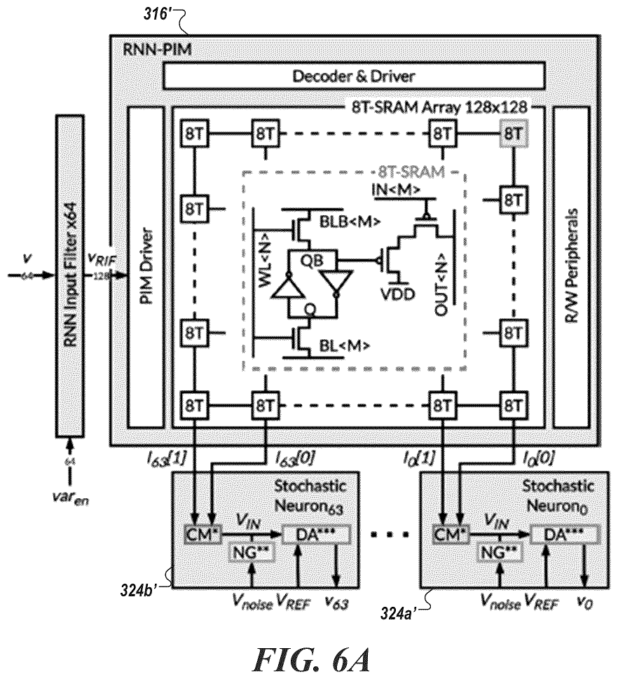

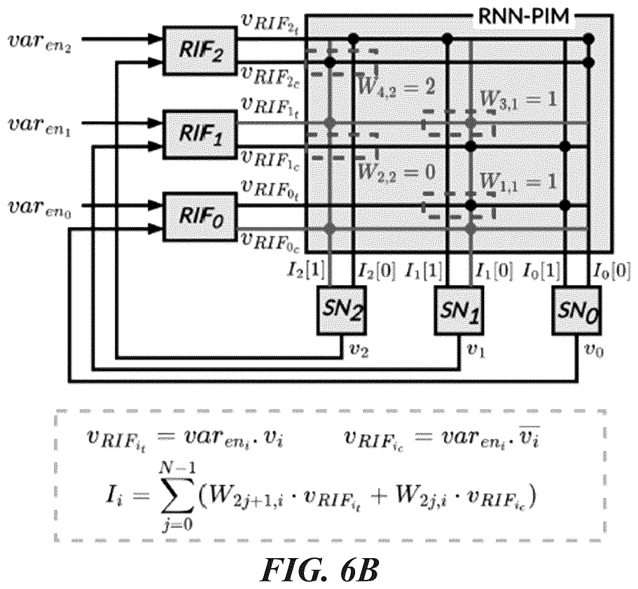

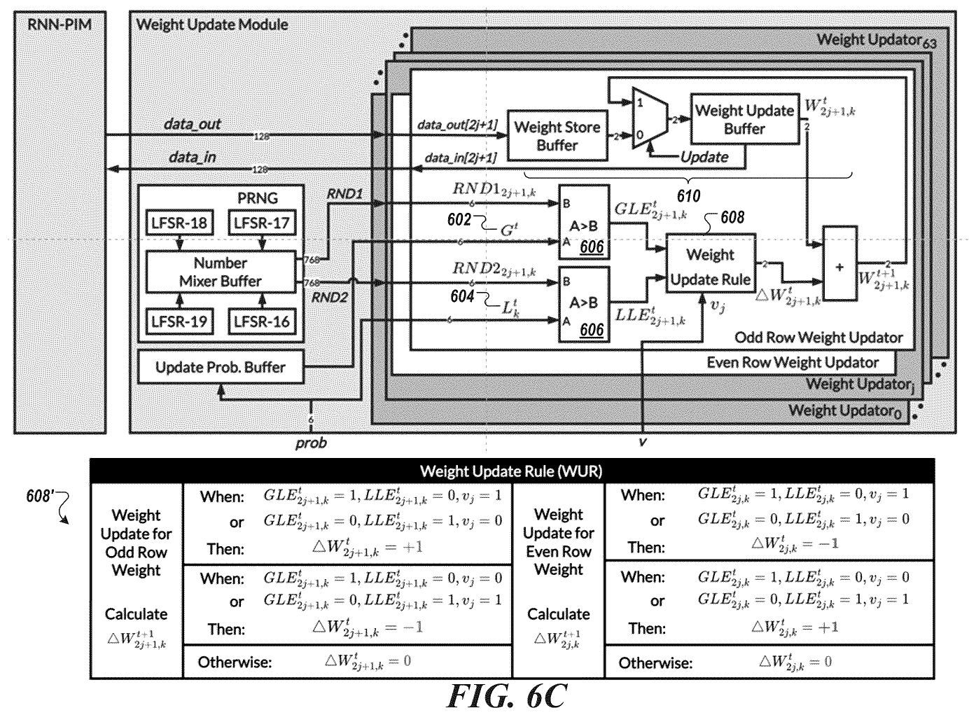

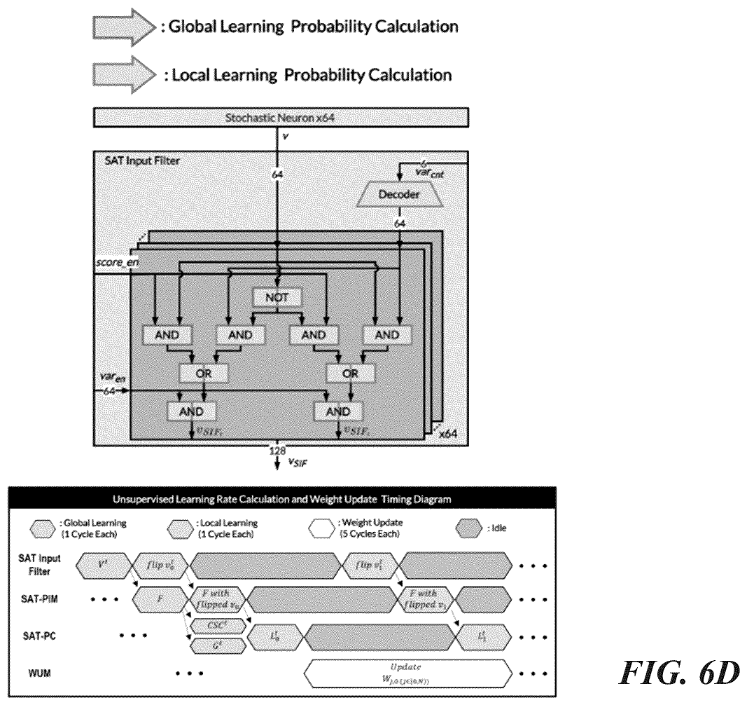

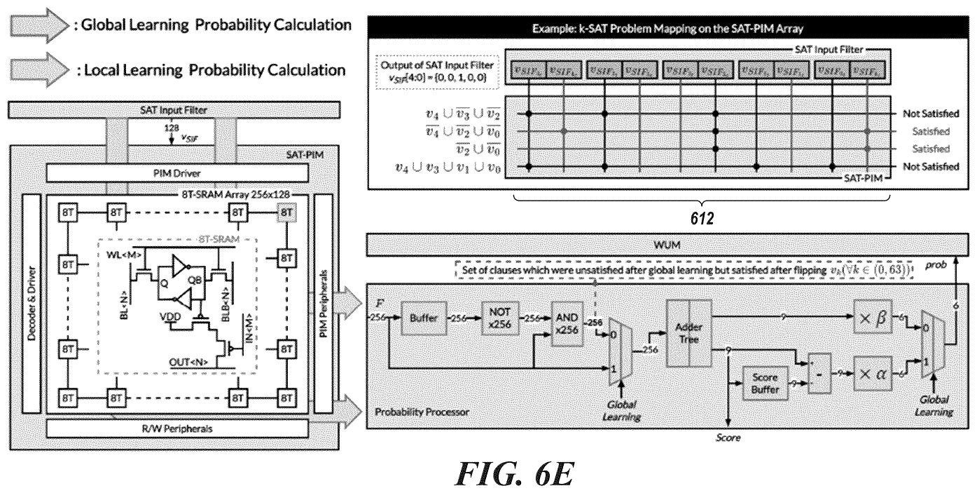

RNN Input Filter. FIG. 4A shows an example, as a non-limiting configuration, of an RNN input filter (RIF) 328 (shown as 328′) that can process the assignment X^{(t)} to create a transformed assignment [symbol] . The transformation is based on a function ƒ, which maps the input vector to an output vector with twice the length of the input vector, having both a positive and negative version of the input vector. The function ƒ can operate on the elements of the input vector. FIG. 6D shows an example circuit implementation of the SAT input filter and its operation.

During operation, the RIF 328′ generates PIM inputs via SRAM rows, with each variable being associated with two rows, namely, a positive row and a negative row corresponding to positive and negative evidence, respectively, for each variable through the dual SRAM rows, to enhance the expressiveness of the variables' status. Without the RIF, only the variable=true case activates the corresponding SRAM row to be multiplied by the row of network weights in which multiplication is used for the neuron output. With the RIF, the second variable=false can provide a separate row of weights that can be additionally used for the neuron output. Indeed, the RIF allows one row between two rows per variable based on the status of the variable. When the variable is excluded from the problem formation, the RIF can disable both rows.

If an element in the input vector X^{(t)} is 1, the RIF can convert the input to a pair of elements {1,0} in an output vector [symbol] . If an element in the input vector X^{(t)} is 0, the RIF can convert the input to a pair of elements {0,1} in the output vector [symbol] . Therefore, the dimension of [symbol] is twice larger than X^{(t)}(| [symbol] |=2|X^{(t)}|). Mathematically, the function ƒ can be defined per Equation 9a.

$$f ( {X}^{( t )} ) = \qquad ( Eq . 9 a )$$

In Equation 9a, [symbol] is the output vector obtained by applying the transformation rules mentioned above to the input vector X^{(t)}.

For instance, given the input vector X^{(t)}={1,0,1}, the RNN input filter can apply an operation per the function ƒ to obtain the output vector [symbol] . The first element 1 is converted to a pair of elements {1,0}; the second element 0 is converted to a pair of elements {0,1}; the third element 1 is converted to a pair of elements {1,0}, to provide [symbol] ={1,0,0,1,1,0}.

FIG. 6D shows an example circuit implementation of the SAT input filter and its operation. In FIG. 6D, during the global learning probability calculation phase, the SIF lets the original variable state pass without changing it. Then, during the local learning probability calculation phase, SIF flips the variables one-by-one before passing the states.

RNN-PIM. FIG. 4A additionally shows an example, as a non-limiting configuration, of an RNN-PIM module 316 (shown as 316′). In the example shown in FIG. 4A, the RNN-PIM module 316′ is configured to perform a vector-matrix multiplication between the input vector [symbol] (407) and the weights matrix W^{(t)}(W^{(t)}∈{0,1}^{2n×2n}) in the memory array to generate an output vector Y^{(t)} (424) per Equation 9b.

$${Y}^{( t )} = {c}_{1} ( \cdot {W}^{( t )} ) ( {c}_{1} : constant ) \qquad ( Eq . 9 b )$$

In Equation 9b, Y^{(t)} (424) represents the output real number vector at time t(Y^{(t)}∈R²ⁿ). [symbol] (407) is a transformed input vector at time t obtained using the function ƒ, and W^{(t)} denotes the weights matrix at time t. c₁ is the analog constant value that converts the digital multiplication results into the analog in-memory computation results. The vector-matrix multiplication takes into account the interactions between the elements of the input vector and the weights, producing the output vector Y^{(t)} (424) that can be used for further processing in the stochastic neuron module 324 (shown as 324′).

In FIG. 4A, the example RNN-PIM 316′ is implemented using a 128×128 array 402 of 8T-SRAM bit cells, supporting 64 variables with 2-bit weight resolution. Other array sizes may be used for other weight resolutions. The RNN-PIM 316′ includes a decoder & driver 404 as well as the read/write peripherals 406 to read/write RNN weights. The PIM driver 403 and 8T-SRAM array 402 carry out the vector-matrix multiplication operation. The accumulated current (Iₓ[y]) is provided to the stochastic neuron 324.

Weight updates are performed through peripheral decoders 404 and read/write circuitry (406) interfacing the bit-cell array. The array 402 has wordlines (WLs) 408 connected vertically through the bit cells, while bitlines (BLs) (410) are oriented horizontally. The in-memory computing operation is executed via the IN and OUT terminals (412, 414, respectively) of each bit cell. Specifically, the PIM inputs are enabled along the horizontal IN signals 412, with multiplication results propagated vertically along the OUT signals 414. The stored 2-bit weights represent the influence of the past states of one variable on the future state of another variable in the RNN computation. This SRAM-based architecture allows parallel in-memory processing using the analog compute mechanisms within the bit cell. Other memory architectures can be used.

Stochastic Neuron. FIG. 4B illustrates a block diagram of a stochastic neuron in accordance with illustrative embodiments. FIG. 4B shows two diagrams (415a, 415b) of an example i^{th} stochastic neuron 324 (shown as 324′, 324″), and FIG. 4C shows the detailed circuit diagram of the stochastic neuron implementation. FIG. 6A shows an example connection between the RNN-PIM 316′ and a set of 64 stochastic neurons 324′ (shown as 324a′ . . . 324b′). FIG. 6B shows an example operation. The state of the neuron, in this example, is decided stochastically based on the weights of RNN-PIM and the previous states of neurons.

In the example shown in FIG. 4B, each stochastic neuron module 324′ includes a current mirror circuit 416, a noise generator circuit 418, and a differential sense amplifier 410 (shown as 416′, 418′, 420′ in an example in FIG. 4C) that, collectively, is configured to generate a new assignment X^{(t+1)} (422) based on the output vector Y^{(t)} (424), a vector of random values R1^{(t)}, and the unit function g.

First, the current mirror circuit 416 combines Yᵢ^{(t)} [1:0] (424) into single real number value V_{IN,i}^{(t)} (426) per Equation 10.

$${V}_{IN , i}^{( t )} = {c}_{2} ( 2 {Y}_{i}^{( t )} [ 1 ] + {y}_{i}^{( t )} [ 0 ] ) ( {c}_{2} : constant ) \qquad ( Eq . 10 )$$

Random number vector R1^{(t)} can be generated using the noise generator 418 and the differential amplifier 420 based on a V_{REF} and Vₙₒᵢₛₑ signal (428a, 428b, respectively). The dimension of the real number random vector, |R1^{(t)}|, is the same as the vector V_{IN}^{(t)} (|R1^{(t)}|=|V_{IN}^{(t)}=n). The function of the stochastic neuron module can be defined per Equation 11.

$${X}^{( t + 1 )} = g ( {V}_{IN}^{( t )} - R {1}^{( t )} ) \qquad ( Eq . 11 )$$

In Equation 11, the subtraction operation between V_{IN}^{(t)} and R1^{(t)} is performed elementwise. The unit step function g is applied to each element of the resulting vector, generating the new assignment X^{(t+1)}. Mathematically, the unit step function g can be defined per Equation 12

$$g ( x ) = \{ \begin{matrix}0 , & x < 0 \\ 1 , & x \geq 0\end{matrix} \qquad ( Eq . 12 )$$

In Equation 12, the vector-matrix multiplication results are accumulated as current on column lines [Y^{(t)}], which are connected to a stochastic neuron 324 containing the current mirror 416, noise generator 418, and a differential amplifier 420. The current mirror 418, in some embodiments, generates membrane potential for the neuron, and a programmable noise generator adds fluctuation [R1^{(t)}]. The differential amplifier 420 determines the next Boolean state by comparing the reference voltage (428a) with the noisy membrane potential [g(V_{IN}^{(t)}−R1^{(t)})].

The analog compute-in-memory affects to result differently to all the different chips. There are two features in the example design: first, process, voltage, and temperature (PVT) variations modify the transistor threshold voltages, impacting the current accumulation for neural activation. This means the precise threshold for determining a neuron output of 0 or 1 can differ for each chip. Second, the ring oscillator-based random number generator relies on thermal noise, which also exhibits some chip-to-chip variation. Therefore, the randomness characteristics will vary slightly between chips. To deal with the physical variations, optimal configurations (Vₙₒᵢₛₑ and V_{ref}) are determined by training, with different configurations for each chip.

Eventually, using Equation 9a in the RIF (328), Equation 9b in RNN-PIM (318), and Equation 11 in the stochastic neuron (324), the equation of the RNN can be represented as Equation 13:

$${Y}^{( t + 1 )} = {c}_{1} ( f ( g ( {c}_{2} {Y}^{( t )} - R {1}^{( t )} ) ) {W}^{( t )} ) \qquad ( Eq . 13 )$$

The stochastic neuron (FIG. 4C) included a ring oscillator-based noise generator and a differential sense amplifier. Due to process variations, stochastic neurons may employ hyperparameter training to optimally tune the randomness of the neuron to find the appropriate V_{ref} and Vₙₒᵢₛₑ configurations.

FIG. 6A shows an example connection between the RNN-PIM 316′ and a set of 64 stochastic neurons 324′ (shown as 324a′ . . . 324b′). FIG. 6B shows an example operation. in FIG. 6B, the state of variables from the previous state is used to compute the vector-matrix multiplication. A 64-bit input of the RNN input filter becomes a 128-bit output. When the variable is 1, the odd row is enabled, and when the variable is 0, the even row is enabled. Because the weights are two bits, two columns of accumulated current are used as an input of the one stochastic neuron.

SAT Input Filter. In the example system, the calculation of the learning probabilities follows a time-series approach. The global learning probability G (338) is calculated first, followed by the local learning probability L (340), for each column of the weight matrix. The SAT input filter 328 generates appropriate inputs for the SAT-PIM 316 to facilitate these calculations. FIG. 4D illustrates an example SAT input filter and SAT-PIM module with M=0:255 and N=0:127, and example outputs generated during global learning probability calculation and local learning probability calculation.

In the example shown in FIG. 4D, during the global learning probability calculation phase, the SAT input filter 328 (shown as 328′) computes (430) the function ƒ per Equation 9a applied to the assignment vector X^{(t)} 334a (shown as 334a′) and generates the output vector [symbol] (334b, see FIG. 3B).

In the local learning probability calculation phase, the SAT input filter module 328′ computes (432) the function ƒ applied to the negation of the assignment vector X^{(t)}[x₁=¬xᵢ] (334c, see FIG. 3B) for each neuron i. X^{(t)}[xᵢ=¬xᵢ] represents the assignment X^{(t)} with the i th element negated per Equation 14.

$${X}^{( t )} [ {x}_{i} = ¬ {x}_{i} ] = \{ {x}_{1}^{( t )} , {x}_{2}^{( t )} , … , ¬ {x}_{i}^{( t )} , … , {x}_{n}^{( t )} \} \qquad ( Eq . 14 )$$

Equation 14 represents the assignment vector X) after negating the i th element. All the other elements remain unchanged. As a result, the module generates a series of output vectors X^{(t)}[xᵢ=¬xᵢ] for i=1, . . . , N, where N is the number of variables. This step-by-step process allows the system to calculate local learning probabilities for each weight of the neuron individually.

These updated input vectors, generated by the SAT input filter module, are then fed into the SAT-PIM module. The SATPIM module aims to find a satisfying assignment for the SAT problem by iteratively updating the truth values of the variables based on the global and local learning probabilities.

SAT-PIM. FIG. 4D additionally shows an example, non-limiting configuration, of an SAT-PIM module 316 (shown as 316′) to generate (434, 436) P(X^{(t)}), per Equation 3, and P(X^{(t)}[xᵢ=¬xᵢ]) based on the input assignment. The module 316 operates with the probability processor 320 to facilitate both global and local learning probability calculations. In the example, SAT-PIM module 316′, each row of the 256-row array represents a clause, and the columns represent variables. The SAT problem is mapped by programming the bit cells to indicate the presence or absence of variables in a clause. Variable states are applied simultaneously to SAT-PIM columns. FIG. 6E shows an example circuit implementation of the RNN-PIM and its operation.

In FIG. 4D, to program the example SAT-PIM module 316′, the clause set P (330, shown as 330′) is first written into the 8T-SRAM array. The WLs (438) are oriented horizontally to select each clause i in turn. The BLs (440) are then used vertically to write the variable status for clause i into the corresponding row of SAT-PIM. Specifically, each clause i contains variables vᵢ, v₂, . . . , vₖ. If a variable vⱼ is positive in clause i, column (2j+1) of row i is set to 1. On the other hand, if vⱼ is negative, column (2j) is set to 1. All other columns in the row are set to 0. The encoding allows the SAT-PIM 316′ to perform an OR operation between the input literals from the SAT input filter 328′ and the stored clause values in the 8T-SRAM array. The PIM inputs are oriented vertically along the IN signals (442), while the OR operation output is propagated horizontally along the OUT signals (444). By leveraging this digital PIM operation, SAT-PIM 316′ can evaluate clauses in parallel. FIG. 4E shows an example of the SAT problem mapping on the SAT-PIM array.

During the global learning probability calculation phase, the input to the SAT-PIM module 316′ is X) (e.g., 334). Based on the OR operation, the module 316′ generates the output P(X^{(t)}) (434) and sends it to the probability processor 320. During the local learning probability calculation phase, the input to the SAT-PIM module 316′ is X^{(t)}[xᵢ=¬xᵢ]. The module 316′ generates P(X^{(t)}[xᵢ=¬xᵢ]) (436) in the time-series from i=1 to i=N and sends it to the probability processor 320. The probability processor 320 subsequently calculates the local learning probabilities (e.g., 340) for each weight of the neuron using the information.

FIG. 6E shows an example circuit implementation of the SAT-PIM 316′ and the probability processor 320′ and their operation. As shown in FIG. 6E, SAT-PIM 316′ checks the satisfaction of the clauses based on the received state of variables. The decoder & driver and the read/write peripherals program the SAT problem onto the SAT-PIM array. SAT-PIM receives the states of the variables filtered by SIF. The PIM driver and 8T-SRAM array perform (612) the OR operation to verify whether each clause is satisfied.

Probability processor. FIG. 4F shows an example, as a non-limiting configuration, of a probability processor 320 (shown as 320′) configured to calculate two learning probabilities: the global learning probability G (e.g., 338) and the local learning probability L (e.g., 340). FIG. 6E additionally shows an example circuit implementation of the RNN-PIM 316′ and the probability processor 320′ and their operation.

The global learning probability, G^{(t)}, may be computed (446) per Equation 15.

$${G}^{( t )} = Sigmoid [ a * \{ S ( {X}^{( t )} ) - S ( {X}^{( t - 1 )} ) \} ] \qquad ( Eq . 15 )$$

In Equation 15, global learning is applied to all the weights in the weight matrix, affecting the entire network. In some embodiments, a sigmoid function is employed in hardware. In other embodiments, because a sigmoid can be resource-intensive, Equation 15 can be modified to a*{S(X^{(t)}) −S(X^{(t-1)}}+(½) with the output range constrained between 0 and 1, e.g., using a set minimum and maximum values accordingly. Recall S(X^{(t)}) is described in relation to Equation 8.

The local learning probability (e.g., 340) may be configured to be different for each column of the weight matrix. Each column i of the weight matrix may be connected to neuron i. The local learning probability Lᵢ^{(t)} can be computed (448a, 448b) per Equation 16.

$${L}_{i}^{( t )} = b [ \sum \{ \overline{P ( {X}^{( t )} )} ∧ P ( {X}^{( t )} [ {x}_{i} = ¬ {x}_{i} ] ) \} ] \qquad ( Eq . 16 )$$

In Equation 16, the equation P̅(̅X̅^̅{̅(̅t̅)̅}̅)̅∧P(X^{(t)}[xᵢ=¬xᵢ]) (within 448a) represents the elementwise conjunction of the two sets P̅(̅X̅^̅{̅(̅t̅)̅}̅)̅ and P(X^{(t)}[xᵢ=¬xᵢ]). The local learning probability may also be constrained to a range between 0 and 1.

While shown as a single module, the probability processor 320 can be implemented in more than one module, e.g., one for each of the learning probabilities.

FIG. 6E shows an example circuit implementation of the SAT-PIM 316′ and the probability processor 320′ and their operation. As discussed above, in FIG. 6E, SAT-PIM 316′ checks the satisfaction of the clauses based on the received state of variables. The decoder & driver and the read/write peripherals program the SAT problem onto the SAT-PIM array. SAT-PIM receives the states of the variables filtered by SIF. The PIM driver and 8T-SRAM array perform (612) the OR operation to verify whether each clause is satisfied.

Additionally, if the clause is satisfied, the PIM result becomes 1, and if the clause is not satisfied, the result becomes 0. The probability processor 320′ calculates the probability based on the 256-bit PIM result. During the global learning probability calculation, 256-bit results are added to generate a 9-bit satisfaction score. This score is used as a global learning probability in the weight update module. During the local learning probability calculation, the probability processor checks how many clauses in dissatisfaction become satisfactory based on the variable flipping. The total number of changes is used as a probability of local learning. Based on these learning probabilities, the weight update module updates the weights of RNN.

Weight update module. FIG. 4G shows an example, as a non-limiting configuration of, the weight update module (WUM) 322 (shown as 322′). FIG. 6C shows an example operation of the weight update module to stochastically update the weights of RNN, e.g., based on a weight update rule, weight update probability, and a pseudo-random number generator.

In the example shown in FIG. 4G, the WUM 322′ is responsible for updating the weight matrix W^{(t)} in the RNN-PIM (e.g., 318) based on the learning probabilities (e.g., 338, 340, shown as 338′ and 340′) computed by the probability processor 320. The new weight values W^{(t+1)} can be calculated per Equation 17.

$${W}_{r , c}^{( t + 1 )} = {W}_{r , c}^{( t )} + ( 2 * - 1 ) ( 2 * {X}_{c}^{( t )} - 1 ) * Δ {W}_{r , c}^{( t )} \qquad ( Eq . 17 )$$

The weight update ΔW_{r,c}^{(t)}, as the output 456 of the weight update module 322′, can be computed per Equation 18.

$$Δ {W}_{r , c}^{( t )} = p \{ g ( {G}^{( t )} - R {2}_{r , c}^{( t )} ) - g ( {L}_{c}^{( t )} - R {3}_{r , c}^{( t )} ) \} \qquad ( Eq . 18 )$$

In Equation 18, the parameters are provided in Table 1.

TABLE 1

| | |
|---|---|
| r | row index |
| c | column index |
| W_{r,c}^{(t)} | the weight value at time t (Equation 17) |
| [symbol] | transformed input vector at time t (Equation 9a) |
| G^{(t)} and L_{c}^{(t)} | global and local learning probabilities, respectively |
| R2_{r,c}^{(t)} and R3_{r,c}^{(t)} | elements of matrices R2^{(t)} and R3^{(t)}, which are |
| | composed of random numbers at time t and have the |
| | same dimensions as the weight matrix W |
| p | precision of the weight update |
| g | unit step function (Equation 12) |

The weight update process incorporates both global and local learning probabilities, adjusting the weights to balance between generating the same output X^{(t+1)} as the input X (global learning) and generating different outputs from the input (local learning). Other algorithms can be used.

In the example, non-limiting configuration, shown in FIG. 4G, the WUM 322′ includes a weight calculator 450, a weight update calculator 452, and a pseudo-random number generator (PRNG) 454. The PRNG 454 generates pseudorandom numbers (RNDs) that are combined to produce two RNDs (R2 and R3). The weight update calculator 452 generates ΔW^{(t)} based on the update probabilities R2 and R3. Weights connected to one output neuron are updated in parallel, and weights for different neurons are updated sequentially [16]. The comparator reads, updates, and writes back the RNN weights in two, one, and two cycles, respectively.

In FIG. 6C, two update rules (global learning and local learning) are employed (602, 604). The global learning probability affects all the neurons, and the local learning probability affects differently to each neuron. The learning probabilities and the random numbers from the PRNG are then compared (606) to decide whether the weights should be updated or not. The weight update rule (608) is used to check whether the weight should be increased or decreased using the global and local learning enablement and the current variable state. An example of the weight update rule 608 (shown as 608′) is provided. The weight update rule decides the weight update based on the global and local learning algorithm. Both algorithms can enhance or diminish the weights of RNN. The weight update rule is based on the current state of the variable, parity of the weight's row number and the global and local learning enablement.

The 2 bits weight is read from the RNN-PIM, updated (610), and is written back to RNN-PIM.

Simulated system dynamics. FIG. 4H shows an example system dynamics 458 of the solving algorithm (i.e., searching the solution space 270). The example dynamics 458 is generated via a simulator that analyzed the score history, network weight matrix data, and the activity of neurons, among others, over time. FIG. 4H illustrates the cost function and the evolution of different system dynamics over time where the x-axis represents the solution space, while the y-axis represents the cost function. The cost function is defined as 1 divided by score, indicating that a lower score corresponds to a higher cost function, while a higher score means a lower cost function.

FIG. 4H, plot 460, further illustrates the evolution of different elements of the system dynamics over time. The normalized SAT is defined as the ratio of satisfied clauses to the total number of clauses. In the early phase of the system, denoted as A (458a), the network weights show chaotic behavior, and neuron status changes frequently. The normalized SAT score is also low at this phase. As time progresses (phase B, 458b), the network weights become more aligned, and neuron activity decreases. The study also observed that normalized SAT score increased in this phase. Eventually, upon solving the problem as marked as C (458c), the system converges, and both network weights and neuron status become fixed. The simulated dynamics demonstrate the example algorithm and the hardware architecture, enabling the system to converge upon discovering the solution to the given problem.

### Experimental Results and Examples

A study was conducted to develop and evaluate a processing-in-memory k-SAT solver using a recurrent stochastic neural network with unsupervised learning. While the embodiments described in the study of the example are configured to solve a Boolean satisfiability problem, it should be understood that embodiments of the present disclosure can be configured to solve other types of problems.

The study shows that the design addressed the limitations of prior designs by offering improved solvability, flexibility, and adaptability to different problem types. Utilizing dual PIM architectures allowed for accelerated neural network computations and enhanced SAT checks, leading to increased efficiency and lower energy usage. By employing the combination of global and local learning algorithms and RNN architecture, the instant system navigated the solution space in a guided fashion. The presented mathematical analysis shows that the various machine learning algorithms can be applied to SAT problems by leveraging the example architecture. With the implementation and measurement of a 65 nm test-chip prototype, the study demonstrated an approach to tackling SAT challenges.

Microarchitecture. The study included example microarchitectures of embodiments of a hardware-based solver. FIG. 3B shows the example system architecture and operation flow. Mixed-signal PIM modules implement the RNN and the crossbar for mapping and computing SAT clauses. Stochastic neurons are realized using analog circuits with adjustable randomness. Digital FSMs calculate RNN weight update probabilities and stochastically update the RNN weights using a pseudorandom number generator. A SAT input filter connects neuron outputs to the SAT-PIM to support learning rules.

The operation flow of the architecture of the hardware-based solver includes: (1) writing the SAT problem (P) to the SAT-PIM memory array, (2) generating the assignment of variables (X) based on the CT-SRNN, (3) calculating the SAT score [S(X)] and global learning probability (G) based on the X values, (4) calculate the local learning probability (L), and (5) update the weights (W) in the RNN-PIM memory array based on G and L.

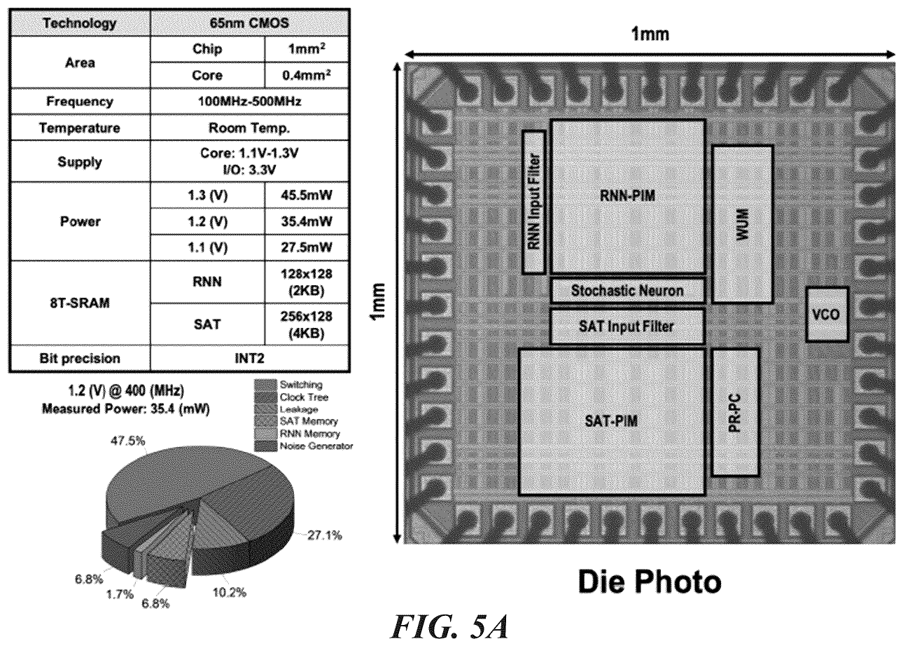

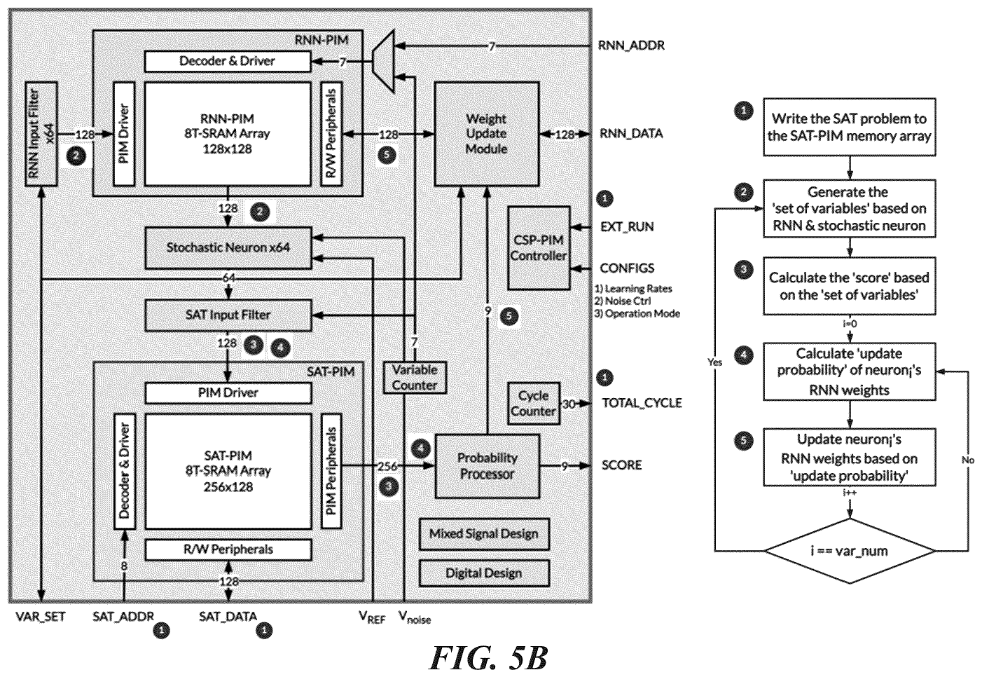

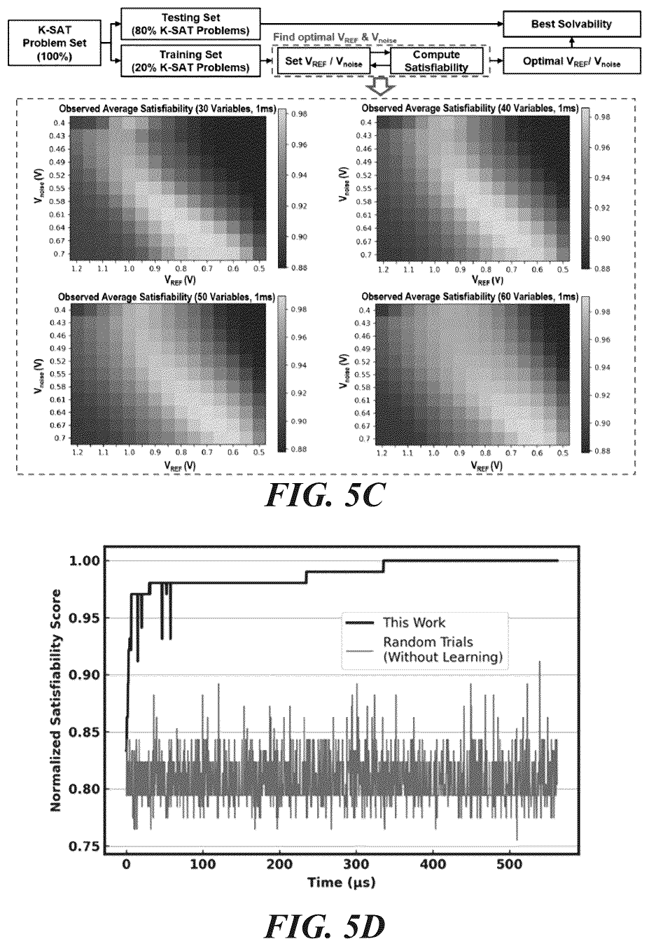

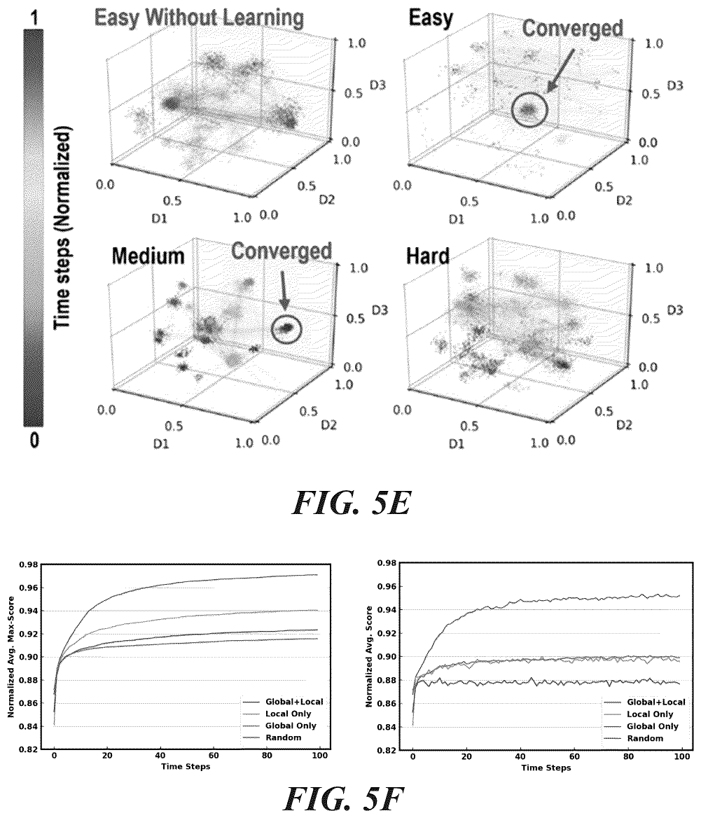

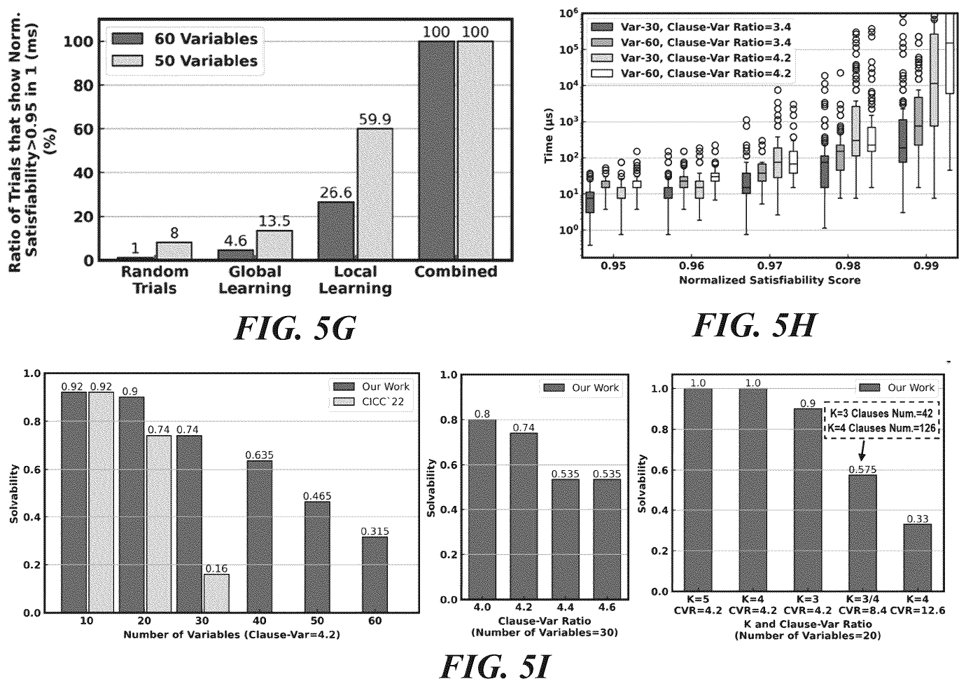

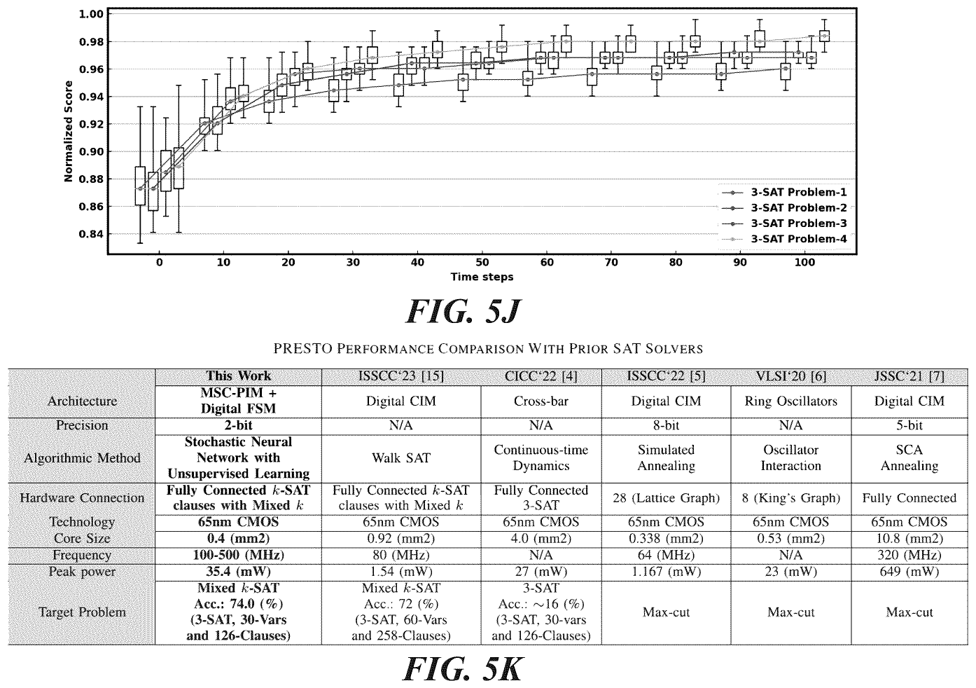

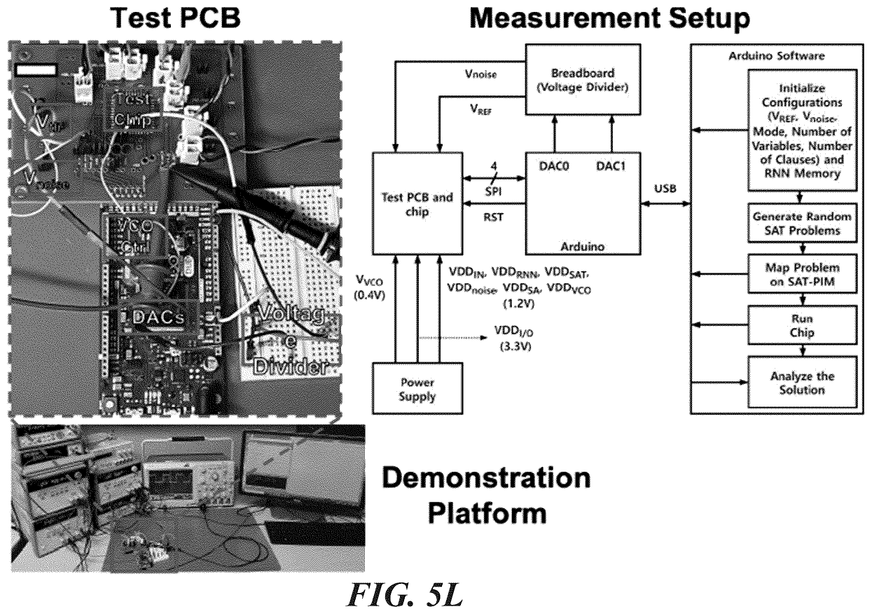

Measurement Results. An example embodiment was fabricated and evaluated as part of the study. FIG. 5A shows a 65 nm CMOS silicon prototype die micrograph and the chip specifications. FIG. 5B shows a micro architecture of a chip fabricated in the study. FIG. 5L shows the test setup and the measurement setup.

In FIG. 5B, the modules include mixed-signal components and digital components. The 0.4 mm² core design includes two 8T-SRAM arrays, which are RNN-PIM and SAT-PIM. Each array has 2- and 4-kB memory capacity, respectively. It consumed 32.5 mW, mainly due to the clock and switching power of the FSM. The test setup and measurement setup included the die, printed circuit board (PCB), and instruments. An in-house firmware was developed to use an Arduino board to map a SAT problem in the chip, configure the chip's operating conditions, and collect/analyze the measurement results. All the SAT problems used in measurement were randomly generated by the random library in Python.

The stochastic neuron (FIG. 4C) included a ring oscillator-based noise generator and a differential sense amplifier. Due to process variations, stochastic neurons may employ hyperparameter training to optimally tune the randomness of the neuron to find the appropriate V_{ref} and Vₙₒᵢₛₑ configurations. Out of the 200 randomly generated three SAT problems, 20% are used to tune V_{ref} and Vₙₒᵢₛₑ, while the remaining 80% are used for testing. FIG. 5C presents the measured average normalized SAT score for the test set. As Vₙₒᵢₛₑ increases, V_{IN} decreases, necessitating a reduction in V_{ref}. When Vₙₒᵢₛₑ is low, the ring oscillator is turned off, and thermal noise is employed to generate stochasticity in the stochastic neuron.

FIG. 5C illustrates an example embodiment of a hyperparameter tuning setup that finds V_{ref} and Vₙₒᵢₛₑ configurations where the averaged normalized SAT score was measured based on the tuned hyperparameters. FIG. 5D illustrates a study of normalized SAT Score history compared to a random trial, according to an example embodiment of the present disclosure.

Normalized SAT Score History: FIG. 5D shows the normalized SAT score across time, for example, three-SAT problem of 126 clauses and 30 variables. A random trial implementation shows a chaotic change in the score that does not converge. In comparison, the example embodiment converges to a 100% normalized SAT score within 350 μs for this problem.

FIG. 5E illustrates a study of time-based system dynamics representation where 60-variable state information is projected to 3D using t-SNE, according to an example embodiment of the present disclosure. A 60-D variable space is reduced to a 3D space using t-distributed stochastic neighbor embedding (t-SNE). The random trials exhibit a chaotic search behavior, while the example embodiment demonstrates rapid convergence to the optimal search area/solution. As the clause-to-variable ratio becomes higher, the system dynamics become more chaotic, and subsequently, and the convergence time increases.

Performance Comparison. FIG. 5F shows the normalized average of scores history over time steps when using different algorithms. Specifically, FIG. 5F illustrates an average of a normalized maximum score and normalized score history for a three-SAT problem with 60 variables and 252 clauses. The two graphs represent the average measurements over time for 200 problems, including the average of maximum scores history and the average scores history. Four algorithms are tested, incorporating a combination of global learning, local learning, and the random trial. Both graphs demonstrate that applying both algorithms simultaneously yields better scores compared with other algorithm settings. In FIG. 5F, random trial demonstrates higher maximum scores than when employing global learning only. On the other hand, in FIG. 5F, random trials show a lower average score than the result using a global learning algorithm only. These results represent the characteristic of global learning to converge toward local optima, while local learning aims to explore the search space in pursuit of higher scores.

FIG. 5G illustrates a comparison of different learning methods, for example, SAT solver, according to embodiments of the present disclosure. In FIG. 5G, the probability of reaching 95% or higher SAT score is shown within 1 ms, as experimented on 1000 random three-SAT problems. The random search yields a 1% success rate for a 60-variable, 252-clause problem compared with 100% success with the example method. Using only global or local learning for the same problem results in 4.6% and 26.6% success rates, respectively.

Satisfiability v. Time. FIG. 5H illustrates the normalized SAT scores of various problems and the distribution of time (μs) taken to reach each respective score. Each box plot is derived from 200 problems with varying variable and clause configurations. Clause-to-variable ratio (CVR) is (number of clauses/number of variables). As the normalized SAT score decreases, the number of variables has a more significant impact on the required convergence time. To attain a higher normalized SAT score, more challenging problems with a higher CVR tend to require a longer time.

Solvability Results. FIG. 5I presents the measured data for the solvability of 200 randomly generated k-SAT problems corresponding to each bar. Solvability is defined as the percentage of instances where all clauses are satisfied (normalized SAT score=1). The graph depicting varying numbers of variables demonstrates that solvability decreases as the number of variables increases. The example design studied achieves a 4.625 times higher solvability compared with prior art [4] for the 30-variable case. A CVR of 4.2 is considered the hard region for the three-SAT problem.

The graph with different clause-variable ratios shows that by increasing the number of clauses while maintaining the same number of variables (30), solvability decreases. The solvability results for different k values, and CVR settings indicate that the example design is adaptable for mapping and solving problems with higher k and mixed-k values. The k=¾ and CVR=8.4 cases comprise 42 clauses with k=3 and 126 clauses with k=4. This case exhibits solvability between the k=3 and CVR=4.2 case and the k=4 and CVR=12.6 case.

Score Distribution for the Same Problem. FIG. 5J demonstrates the variable of the normalized scores obtained from multiple measurements of the same SAT problem. Specifically, FIG. 5J illustrates box plots of normalized score distribution over time steps constructed based on 100 measurements of 3-SAT problems, where the three-SAT problem includes 60 variables and 252 clauses, according to an example embodiment of the present disclosure. A box plot is used to represent the variation of the maximum score over time. A total of four problems are assessed, and each problem is measured 100 times. The x-axis represents the time steps, and the y-axis represents the normalized score. The box plot is constructed by each ten-time steps, and the solid line is used to connect the medians of each box plot to represent the evolution of each problem. The figure shows the difficulty in obtaining scores varies across different problems. For example, from time step 20, Problem 1 achieves a lower score compared with Problem 4. From the 100 measurement results and 100 time steps, the maximum score for Problem 1 aligns closely with the median score of Problem 4.

Comparison Table. FIG. 5K illustrates a table comparing the example embodiment of the present disclosure to alternative algorithms. FIG. 5K presents a performance comparison between the example PRESTO design and prior SAT solvers. The table highlights various characteristics of each design, such as architecture, precision, algorithmic method, hardware connection, technology, core size, frequency, peak power, and target problem.

The example PRESTO design features a mixed-signal circuit-based PIM (MSC-PIM) combined with a digital FSM. It operates with 2-bit precision and employs a stochastic neural network with unsupervised learning as its algorithmic method. The hardware connection is fully connected for k-SAT clauses with mixed k values. The design is based on 65-nm CMOS technology with a core size of 0.4 mm². Its operating frequency ranges between 100 and 500 MHz, and it has a peak power of 35.4 mW. The target problem for the PRESTO design is mixed k-SAT with an accuracy of 74.0% for a three-SAT problem with 30 variables and 126 clauses.

Compared with other SAT solvers, the example design offers several benefits, such as a distinctive algorithmic method and improved hardware connection adaptability. The algorithm employed in the example embodiment adapts the search process according to the local impact of each variable on the objective function. Furthermore, the architecture of the example design enables researchers to apply not only the unsupervised learning approaches described herein but also various other optimization techniques. The example embodiment studied effectively handles fully connected k-SAT clauses with mixed-k problems, showcasing its versatility and potential for solving a wide range of SAT challenges.

### Discussion

The instant study developed a processing-in-memory (PIM)-based satisfiability (SAT) solver [called Processing-in-memory-based SAT solver using a Recurrent Stochastic neural network (PRESTO)] employing a mixed-signal circuit-based PIM (MSCPIM) architecture combined with a digital finite state machine (FSM) for solving SAT problems. The example embodiment leveraged a stochastic neural network with unsupervised learning. The architecture supported fully connected k-SAT clauses with mixed-k problems, highlighting its versatility in handling a wide range of SAT challenges. A test chip was fabricated in 65-nm CMOS technology with a core size of 0.4 mm² and had an operating frequency range of 100-500 MHz and a peak power of 35.4 mW. The measurement results show that the system achieved a 74.0% accuracy for three SAT problems with 30 variables and 126 clauses.

Boolean satisfiability (k-SAT, k≥3) represents an NP-complete combinatorial optimization problem (COP) with applications across various fields, including communication systems, flight networks, supply chains, and finance, among others [1], [2], [3]. The complexity and importance of these problems have led to the development of specialized application-specific integrated circuits (ASICs) for solving SAT (and other COPs). Several techniques, including continuous-time dynamics [4], simulated annealing [5], oscillator interactions [6], and stochastic automata annealing [7], have been used for solving SAT problems in hardware. Existing hardware-based SAT solvers achieve relatively low solvability for complex SAT problems. [4] indicates only a 16% success rate for solving instances with 30 variables and 126 clauses; moreover, existing solvers rely on small, fixed network topologies (King's graph, Lattice Graph, or three-SAT) [4], [5], [6], [7], [8], [9], [10], [11]. These fixed network topologies restrict the flexibility of problems that can be mapped to the hardware.

In the instant study, the Processing-in-memory-based SAT solver used a Recurrent Stochastic neural network with unsupervised learning as a continuous-time stochastic recurrent neural network (CTSRNN) controlled by a discrete-time finite state machine (DT-FSM). The example solver involves N(=64) variables and M(=256) clauses. The variables are represented by binary stochastic neurons. A single-layer recurrent neural network (RNN) guides the neurons' states by controlling a set of random processes. The solver handles k-SAT problems by programming them into a crossbar array, which calculates the Boolean states of clauses. A digital finite state machine (FSM) computes the current SAT score from the Boolean states of the clauses and updates the RNN weights to control the stochasticity of neurons. The RNN weights are updated through stochastic unsupervised global and local learning rules. Global learning guides the system toward a higher number of satisfied clauses, while local learning helps it escape local minima and explore the local problem region. As iterations progress, weights and neurons converge to the global optimal states.

The system included processing-in-memory (PIM) architecture for computing the CT-SRNN and for checking the SAT score of a specific solution. The example PIM-based accelerator improves performance and/or reduces the energy of the neural network computation in the CT-SRNN [12], [13]. Furthermore, PRESTO integrates a k-SAT problem within the memory array to compute the SAT score efficiently. The PIM-based computation of the SAT score leads to better utilization of the parallelism and locality of the k-SAT problem [14], [15]. PIM also improves the efficiency of checking the SAT score by performing simultaneous processing on multiple memory cells.

### Other Examples

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

As discussed herein, a “subject” may be any applicable human, animal, or other organism, living or dead, or other biological or molecular structure or chemical environment, and may relate to particular components of the subject, for instance, specific tissues or fluids of a subject (e.g., human tissue in a particular area of the body of a living subject), which may be in a particular location of the subject, referred to herein as an “area of interest” or a “region of interest.”

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications, and publications, as listed below and throughout this document, are hereby incorporated by reference in their entirety herein.
[1] M. Davis, G. Logemann, and D. Loveland, “A machine program for theorem-proving,” Commun. ACM, vol. 5, no. 7, pp. 394-397, July 1962.
[2] S. A. Cook, “The complexity of theorem-proving procedures,” in Proc. 3rd Aππ [symbol] . ACM Symp. Theory Comput., 1971, pp. 151-158.
[3] E. Boros and P. L. Hammer, “Pseudo-Boolean optimization,” Discrete Appl. Math., vol. 123, nos. 1-3, pp. 155-225, November 2002.
[4] M. Chang, X. Yin, Z. Toroczkai, X. Hu, and A. Raychowdhury, “An analog clock-free compute fabric base on continuous-time dynamical system for solving combinatorial optimization problems,” in Proc. IEEE Custom Integr. Circuits Conf. (CICC), April 2022, pp. 1-2.
[5] Y. Su, T. T. Kim, and B. Kim, “FlexSpin: A scalable CMOS Ising machine with 256 flexible spin processing elements for solving complex combinatorial optimization problems,” in Proc. IEEE Int. Solid-State Circuits Conf. (ISSCC), vol. 65, February 2022, pp. 1-3.
[6] I. Ahmed, P.-W. Chiu, and C. H. Kim, “A probabilistic self-annealing compute fabric based on 560 hexagonally coupled ring oscillators for solving combinatorial optimization problems,” in Proc. IEEE Symp. VLSI Circuits, June 2020, pp. 1-2.
[7] K. Yamamoto et al., “STATICA: A 512-spin 0.25M-weight annealing processor with an all-spin-updates-at-once architecture for combinatorial optimization with complete spin-spin interactions,” IEEE J. Solid-State Circuits, vol. 56, no. 1, pp. 165-178, January 2021.
[8] Y. Su, H. Kim, and B. Kim, “CIM-spin: A scalable CMOS annealing processor with digital in-memory spin operators and register spins for combinatorial optimization problems,” IEEE J. Solid-State Circuits, vol. 57, no. 7, pp. 2263-2273, July 2022.
[9] T. Takemoto, M. Hayashi, C. Yoshimura, and M. Yamaoka, “2.6 a 2×30k-spin multichip scalable annealing processor based on a processing-in-memory approach for solving large-scale combinatorial optimization problems,” in Proc. IEEE Int. Solid-State Circuits Conf. (ISSCC), February 2019, pp. 52-54
[10] T. Takemoto et al., “4.6 a 144 Kb annealing system composed of 9×16 Kb annealing processor chips with scalable chip-to-chip connections for large-scale combinatorial optimization problems,” in Proc. IEEE Int. Solid-State Circuits Conf. (ISSCC), vol. 64, February 2021, pp. 64-66.
[11] M. Yamaoka, C. Yoshimura, M. Hayashi, T. Okuyama, H. Aoki, and H. Mizuno, “A 20k-spin Ising chip to solve combinatorial optimization problems with CMOS annealing,” IEEE J. Solid-State Circuits, vol. 51, no. 1, pp. 303-309, January 2016.
[12] P. Chi et al., “PRIME: A novel processing-in-memory architecture for neural network computation in ReRAM-based main memory,” in Proc. ACM/IEEE 43rd [symbol] . Int. Symp. Comput. Archit. (ISCA), June 2016, pp. 27-39.
[13] A. Shafiee et al., “ISAAC: A convolutional neural network accelerator with in-situ analog arithmetic in crossbars,” in Proc. ACM/IEEE 43rd Arnx. Int. Symp. Comput. Archit. (ISCA), June 2016, pp. 14-26.
[14] D. Kim, N. M. Rahman, and S. Mukhopadhyay, “29.1 a 32.5 mW mixed-signal processing-in-memory-based k-sat solver in 65 nm CMOS with 74.0% solvability for 30-variable 126-clause 3-sat problems,” in Proc. IEEE Int. Solid-State Circuits Conf. (ISSCC), February 2023, pp. 28-30.
[15] S. Xie et al., “29.2 snap-SAT: A one-shot energy-performance-aware all-digital compute-in-memory solver for large-scale hard Boolean satisfiability problems,” in Proc. IEEE Int. Solid-State Circuits Conf. (ISSCC), February 2023, pp. 420-422.
[16] D. Kim, X. She, N. M. Rahman, V. C. K. Chekuri, and S. Mukhopadhyay, “Processing-in-memory-based on-chip learning with spike-time-dependent plasticity in 65-nm CMOS,” IEEE Solid-State Circuits Lett., vol. 3, pp. 278-281, 2020.

What is claimed:

1. A co-processor comprising:
a solver circuit comprising a neural network configured for unsupervised learning, the solver circuit comprising:
a binary input interface configured to receive binary inputs corresponding to variables and clauses for a Boolean problem;
a state machine memory module a crossbar array of rows and column, collectively, corresponding to variables and clauses, the crossbar array being used to map and compute Boolean states of clauses, wherein each bit-cell in the array indicates a presence or absence of variables in a clause;
neuron circuits coupled to the state machine memory module to generate assignment of the variables;
a neural network acceleration module having arrays of weights corresponding to nodes in a neural network;
a state machine circuit operably coupled to state machine accelerator module, the binary input interface, and the neural network acceleration module, wherein the state machine circuit is configured to (i) compute a score from the Boolean states of the clauses from weights (ii) determine a plurality of learning probabilities to generate a plurality of weights based on the plurality of learning probabilities; and (iii) provide the plurality of weights to NN memory module,
wherein the weights of the state machine memory module are iteratively updated through unsupervised global learning rules and local learning rules, the global learning guides solver towards the higher number of satisfied clauses, and the local learning guides the system to explore a local problem region.

2. The co-processor of claim 1, wherein the state machine circuit comprises a processor circuit configured to output the plurality of learning probabilities.

3. The co-processor of claim 2, wherein the state machine circuit comprises a weight update circuit operably coupled to the probability processor circuit, wherein the weight update circuit is configured to determine the plurality of weights using the plurality of learning probabilities.

4. The co-processor of claim 1, wherein the neuron circuits comprise analog neuron circuits having adjustable randomness.

5. The co-processor of claim 4, wherein the neuron circuits comprise stochastic neurons.

6. The co-processor of claim 1, wherein at least one of the state machine memory module and the neural network memory module comprises processing in memory (PIM) controller.

7. The co-processor of claim 6, wherein at least one of the state machine memory module and the neural network memory module comprises SRAM.

8. The co-processor of claim 1, wherein the state machine circuit comprises a digital finite-state machine (FSM) configured to compute current satisfiability score from the Boolean states of the clauses and updates the weights to NN memory module to control stochasticity of the neuron circuits.

9. The co-processor of claim 8, wherein the state machine circuit comprises an input filter configured to process the assignment of the variables to map an input vector to an output vector according to a set of predefined rules.

10. The co-processor of claim 1, wherein the neural network comprises a recurrent neural network.

11. The co-processor of claim 1, wherein the co-processor is implemented with a host processing unit.

12. The co-processor of claim 1, wherein the co-processor is implemented as an external integrated circuit.

13. The co-processor of claim 1, wherein the solver circuit is configured to solve a Boolean Satisfiability problem (SAT).

14. A method for evaluating satisfiability, the method comprising:
receiving binary inputs corresponding to variables and clauses for a Boolean problem;
mapping a plurality of Boolean states corresponding to the clauses of the Boolean problem;
generating an assignment of variables based on the Boolean problem by a plurality of neuron circuits;
computing a score for the assignment of variables;
determining a plurality of learning probabilities to generate a plurality of weights based on the plurality of learning probabilities;
inputting the plurality of weights to a neural network acceleration module, wherein the neural network acceleration module is configured to update the weights of a state machine memory module iteratively to guide a solver toward a higher number of satisfied clauses of the Boolean problem.

15. The method of claim 14, wherein the plurality of neuron circuits comprise analog neuron circuits having adjustable randomness.

16. The method of claim 14, wherein the plurality of neuron circuits comprise stochastic neurons.

17. The method of claim 14, wherein the Boolean problem comprises a Boolean SAT.

18. The method of claim 14, wherein the state machine memory module comprises processing in memory (PIM) controller.

19. The method of claim 14, further comprising filtering the binary inputs based on a set of predefined rules.

20. The method of claim 14, wherein the plurality of learning probabilities comprise global learning probabilities and local learning probabilities.
